(19) United States
(12) Patent Application Publication
(10) Pub. No.: US 2015/0268932 A1
(43) Pub. Date: Sep. 24, 2015

(54) SYSTEMS AND METHODS TO GENERATE A PLAYLIST FROM A MEDIA MAP

(71) Applicant: MediaGraph, LLC, Berkeley, CA (US)

(72) Inventors: Orion Reblitz-Richardson, Berkeley, CA (US); Alex Lee Kerfoot, Oakland, CA (US); Randall Breen, San Rafael, CA (US); Sina Jafarzadeh, San Francisco, CA (US); A. Peter Swearengen, San Francisco, CA (US); William Ralph Wright, Oakland, CA (US)

(21) Appl. No.: 14/716,673

(22) Filed: May 19, 2015

Related U.S. Application Data
(63) Continuation of application No. 14/716,061, filed on May 19, 2015.
Application No. 14/716,061 is a continuation of application No. 14/714,705, filed on May 18, 2015.
Application No. 14/714,705 is a continuation of application No. 14/336,997, filed on Jul. 21, 2014.
Application No. 14/336,997 is a continuation of application No. 14/214,372, filed on Mar. 14, 2014.
(60) Provisional application No. 61/928,626, filed on Jan. 17, 2014.
(60) Provisional application No. 61/800,577, filed on Mar. 15, 2013.
(60) Provisional application No. 62/002,409, filed on May 23, 2014.

(51) Int. Cl. G06F 7/36; G06F 3/0484

(52) U.S. Cl. CPC G06F 7/36; G06F 3/04842

(57) ABSTRACT

Increasingly, large libraries of digital media items such as music, movies, and images are maintained. One way to consume the media items is via playlists. Playlists are an ordered list of some of the media items according to a theme or a progression from one theme to another theme. Systems and methods described herein allow a user to request generation of a playlist via a media map of the media library. The request can be in a variety of forms including: an identification of a region, identifications of starting and ending points, identification of a defined area of the media map, a gesture identifying a path through the media map, and an identification of a metadata tag associated with some of the media items within the media library. Further, branching playlists can be generated from a currently presented media item, which may itself be from a generated playlist.

### PRIORITY CLAIM

This non-provisional U.S. patent application is a continuation of U.S. patent application Ser. No. 14/716,061 filed May 19, 2015, which is a continuation of U.S. patent application Ser. No. 14/714,705 filed May 18, 2015, which is a continuation of U.S. patent application Ser. No. 14/336,997 filed Jul. 21, 2014, which is a continuation of U.S. patent application Ser. No. 14/214,372 filed Mar. 14, 2014, which claims priority to, and the benefit of, U.S. Provisional Patent Application No. 61/800,577 filed Mar. 15, 2013 and U.S. Provisional Patent Application No. 61/928,626 filed Jan. 17, 2014, the entirety of each of which is hereby incorporated by reference herein. This non-provisional U.S. patent application also claims priority to, and the benefit of, U.S. Provisional Patent Application No. 62/002,409 filed May 23, 2014, which is also hereby incorporated by reference herein.

### BACKGROUND

1. Field

This U.S. patent application relates generally to managing libraries of content, and, more specifically, to providing a playlist of media items from a media map of the libraries of content.

2. Description of Related Art

With the increasing popularity of digital media, users are able to amass larger and larger libraries. Some types of content, such as music and photos, are particularly conducive to being shown or played one after the next. However, playlist generation is often manually performed by a user requiring both time and expertise.

Some technologies currently exist that can automatically generate playlists from a digital media library. However, some of these technologies can only dumbly shuffle media items in the library. Other, slightly more sophisticated, technologies rely on the user manually creating lengthy heuristics that require metadata that is not native to the library. Thus, the user is required to use other programs to add metadata to the media library or to manually add the desired metadata to the library. Without the user having expertise in heuristics and adequate metadata, the automatically generated playlists can include undesired media items or can inadvertently include media items that do not comply with the user's idea of which media items should be included in the playlist.

### SUMMARY

According to some embodiments, a method comprises: obtaining, by a computing system, a media map comprising media map cells corresponding to media items, the media map including a plurality of regions, each region comprising a portion of the media map cells and sub-divided into sub-regions; receiving, by the computing system, a selection of a region of the plurality of the regions of the media map that instructs the computer system to generate a playlist of media items from the selected region; determining, by the computing system, a selection quantity of the media items corresponding to the media map cells from each sub-region of the selected region based on: i) a target length of the playlist, and ii) a total number of media items corresponding to the media map cells in the selected region; selecting, by the computing system and from each sub-region, a number of media items equal to the selection quantity, by selecting: i) a representative media item of the sub-region, and ii) additional media items that are descendants of the representative media item; and ordering, by the computing system and according to sub-region, the selected representative media items and the selected additional media items.

According to some embodiments, a method comprises: obtaining, by a computing system, a media map comprising media map cells corresponding to media items, the media map including a plurality of regions, each region comprising a portion of the media map cells and sub-divided into sub-regions; receiving, by the computing system, a user selection of a starting media map cell and a user selection of an ending media map cell within the media map that instructs the computing system to generate a playlist of media items that begins with a media item corresponding to the starting media map cell and ends with a media item corresponding to the ending media map cell; determining, by the computing system, a target prominence range based on a prominence level of the starting media map cell and a prominence level of the ending media map cell; identifying, by the computing system, candidate media map cells within the target prominence range that are located in the media map between the starting media map cell and the ending media map cell; determining, by the computing system, a shortest path from the starting media map cell to the ending media map cell traversing the candidate media map cells; selecting, by the computing system, media items corresponding to the traversed candidate media map cells; and ordering, by the computing system, a first media item corresponding to the starting media map call, the selected media items, and a second media item corresponding to the ending media map cell according to the determined shortest path.

According to some embodiments, a method comprises: obtaining, by a computing system, a media map comprising media map cells corresponding to media items, the media map including a plurality of regions, each region comprising a portion of the media map cells and sub-divided into sub-regions; receiving, by the computing system, a user-defined area encompassing a portion of at least one of the sub-regions of the media map; calculating, by the computing system, a total number of media items corresponding to the media map cells within the user-defined area; determining, by the computing system, for each sub-region having at least a portion encompassed by the user-defined area, a selection quantity of the media items corresponding to the media map cells within the user-defined area for selection based on: i) a target length of the ordered list, and ii) the total number of media items; selecting, by the computing system, representative media items within the user defined area and children of the representative media items within the user defined area; and ordering, by the computing system and according to sub-region, the representative media items and the children of the representative media items.

According to some embodiments, a method comprises: obtaining, by a computing system, a media map comprising media map cells corresponding to media items, the media map including a plurality of regions, each region comprising a portion of the media map cells and sub-divided into sub-regions; receiving, by the computing system, a user-defined path traversing at least one of the sub-regions of the media map; selecting, by the computing system, media items corresponding to media map cells traversed by the user-defined path; determining, by the computing system, a likelihood of inclusion of additional media items based on a distance between the media map cell to which the additional media item corresponds and the user-defined path; selecting, by the computing system, an additional media item based on its likelihood of inclusion; and ordering, by the computing system, the selected additional media item and the selected identified media items based on the user-defined path.

According to some embodiments, a method comprises: obtaining, by a computing system, a media map comprising media map cells corresponding to media items, the media map including a plurality of regions, each region comprising a portion of the media map cells and sub-divided into sub-regions; receiving, by the computing system, an identification of at least one metadata tag associated with a media item of the media items; identifying, by the computing system, a plurality of the media items associated with the at least one metadata tag; identifying, in the media map and by the computing system, a plurality of the media map cells, including a starting media map cell and an ending media map cell, each of the plurality of the media map cells corresponding to one of the identified plurality of the media items; identifying, by the computing system, candidate media map cells that are located in the media map between the starting media map cell and the ending media map cell; determining, by the computing system, a shortest path from the starting media map cell to the ending media map cell traversing the candidate media map cells; selecting, by the computing system, media items corresponding to the traversed candidate media map cells; and ordering, by the computing system, a first media item corresponding to the starting media map call, the selected media items, and a second media item corresponding to the ending media map cell, according to the shortest path.

According to some embodiments, a method comprises: obtaining, by a computing system, a media map comprising media map cells corresponding to media items, the media map including a plurality of regions, each region comprising a portion of the media map cells and sub-divided into sub-regions; identifying, by the computing system, at least one metadata tag associated with a currently presented media item of the media items; identifying, by the computing system, a plurality of the media items associated with the at least one metadata tag; identifying, in the media map and by the computing system, a plurality of the media map cells, including a starting media map cell corresponding to the currently presented media item and an ending media map cell, each of the plurality of the media map cells corresponding to one of the identified plurality of the media items; identifying, by the computing system, candidate media map cells that are located in the media map between the starting media map cell and the ending media map cell; determining, by the computing system, a shortest path from the starting media map cell to the ending media map cell traversing the candidate media map cells; selecting, by the computing system, media items corresponding to the traversed candidate media map cells; and ordering, by the computing system, the currently presented media item corresponding to the starting media map call, the selected media items, and a second media item corresponding to the ending media map cell, according to the shortest path.

### BRIEF DESCRIPTION OF THE DRAWINGS

FIG. 1 is an example of a media map, according to some embodiments.

FIG. 2 is an example environment in which various embodiments can be implemented, according to some embodiments.

FIG. 3 is a flowchart of an example method for generating a playlist of media items from a region of a media map.

FIG. 4 is an example portion of a region of a media map.

FIG. 5 is a table of values used to select songs from sub-regions of the region of the media map.

FIG. 6 depicts the example portion of the region of the media map and an example ordering of the playlist generated from the sub-regions.

FIG. 7 is a flowchart of an example method for generating a playlist of media items from a media map cell corresponding to a starting media item and a media map cell corresponding to an ending media item.

FIG. 8 is an example portion of a region of a media map where a user has provided the starting media item and the ending media item of a requested playlist.

FIG. 9 is an example portion of the region of the media map depicting a generated playlist that begins at the media map cell corresponding to the starting media item and ends at the media map cell corresponding to the ending media item.

FIG. 10 is a flowchart of an example method for generating a playlist of media items from a user-defined area of a media map.

FIG. 11 is an example portion of a region of the media map depicting a playlist request that specifies a user-defined area of the region.

FIG. 12 is a table of values used to select songs from sub-regions within the user-defined area.

FIG. 13 is a flowchart of an example method for generating a playlist of media items from a user-defined path through the media map.

FIG. 14 is a diagram of a user interface input mechanism to request a playlist by allowing the user to draw a path through a region of the media map.

FIG. 15 depicts a portion of a region of the media map in which a user has requested a playlist by drawing a path.

FIG. 16 is an example portion of the region of the media map and depicting a playlist generated from the user-drawn path.

FIG. 17 is a flowchart of an example method for generating a playlist of media items from a selected metadata tag.

FIG. 18 depicts a simplified version of the media map indicating a quantity of media items associated with the selected metadata tag within each sub-region.

FIG. 19 depicts the simplified version of the media map indicating distances between highlighted media map cells therein.

FIG. 20 depicts the simplified version of the media map depicting an example path traversing the sub-regions of the region.

FIG. 21 depicts the simplified version of the media map indicating a number of media items to select from each of the traversed sub-regions and an example ordering of the playlist.

FIG. 22 depicts an example portion of the media map depicting a previously generated playlist.

FIG. 23 depicts the example portion of the media map and a first branching playlist.

FIG. 24 depicts the example portion of the media map and a second branching playlist.

FIG. 25 depicts the example portion of the media map and the acceptance of the second branching playlist.

FIG. 26 is a flowchart of an example method for generating a playlist of media items based on similarity between the media items.

FIG. 27 is an example portion of a region of a media map which includes a graphical representation showing a connection between media items.

### DETAILED DESCRIPTION

Media libraries can contain hundreds, if not thousands, of digital media items including music, movies, and images. To efficiently and effectively access the media items as a continuous stream, a user can generate a playlist of a sub-set of the media items in the library. The playlist is an ordered list of media items that can be presented (e.g., performed, played, or displayed) consecutively. In most instances, the playlist includes related media items that each contribute to a theme, a genre, a mood, or some other commonality.

The playlist is generated from a media map that displays the media items in the library in a way that expresses relationships or similarities between media items, such as genre, mood, or decade. In some instances, the media map is a two-dimensional Voronoi map where each Voronoi cell corresponds to a media item. The user can submit a playlist request in a variety of ways based on the arrangement of the media items in the media map. The playlist, once generated, is provided to the user. The user can generate a new playlist or select a provided branch from a current playlist to change which media items are presented next.

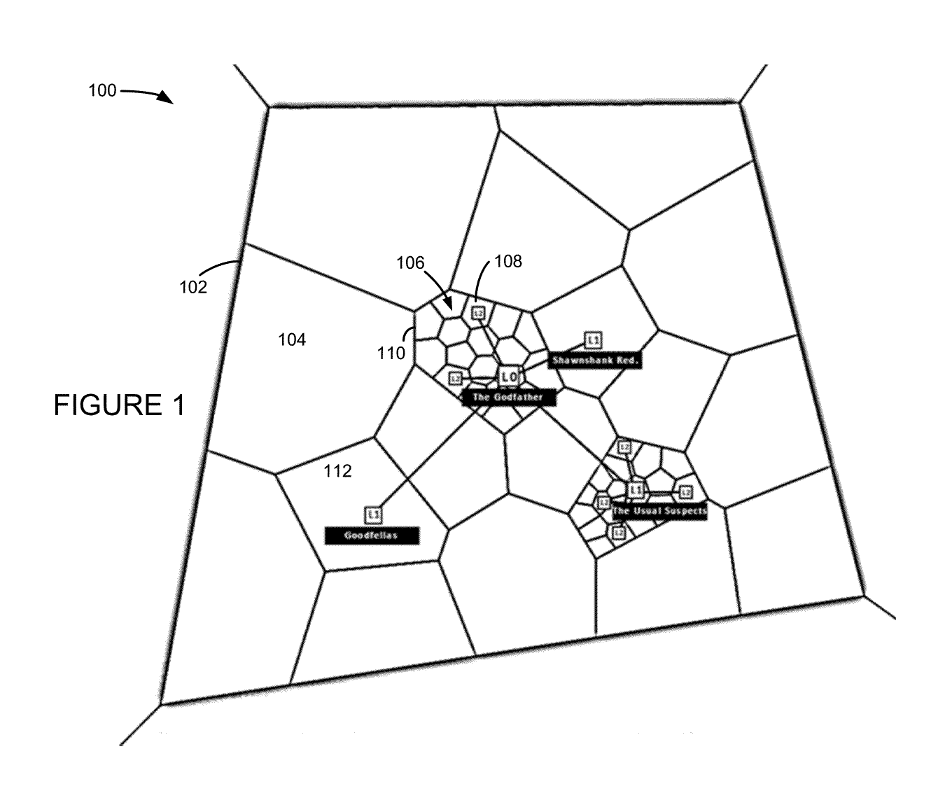

FIG. 1 is an example of a media map 100, according to one embodiment. The media map 100 is generated as a Voronoi diagram. Voronoi diagrams are used by mathematicians to divide a two-dimensional region into a number of cells, where each cell identifies a region about a point. Given a set of points distributed in space, Voronoi diagrams can be quickly generated and/or re-generated by computers. By manipulating the positions of the set of points, the Voronoi diagram can be changed. Further, mathematical techniques, such as Lloyd's relaxation, can be used to refine Voronoi diagrams.

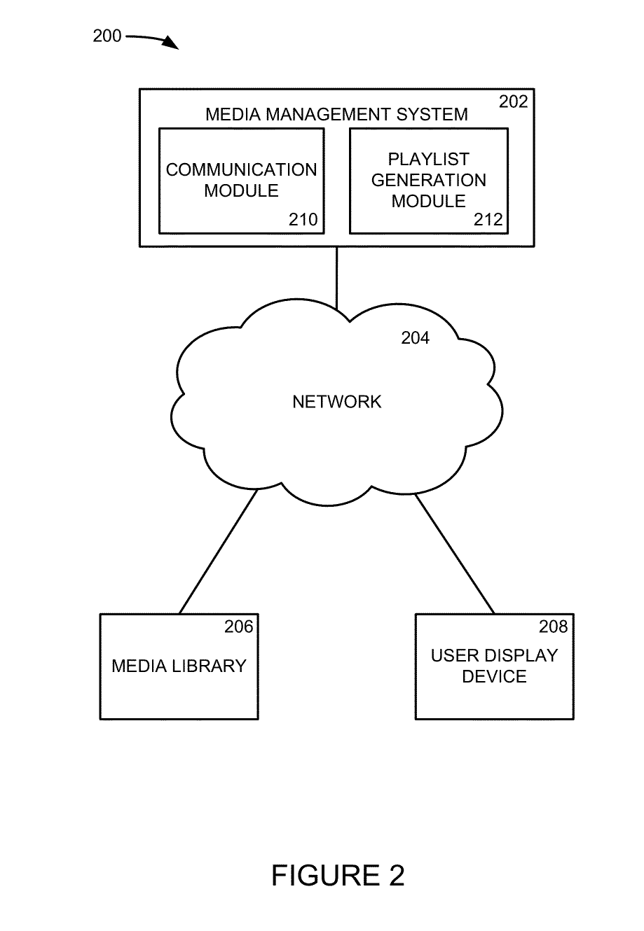

The media map 100 includes a number of Voronoi cells that each are assigned to, and represent, a corresponding media item, a pseudo node, or a filler node in a hierarchical tree (as described in greater detail in connection with FIG. 2). The media map 100 has similar media items placed in proximity to other similar media items and according to a hierarchy where a media item can be the parent or the child of another media item. Child media items are positioned within a subdivision of the Voronoi cell that represents the parent media item.

The size of the cell depends on a prominence level of the media item, the pseudo node, or the filler node. The prominence level of a media item is a quantitative indication of its popularity relative to other, similar media items. Media items having a higher prominence level are assigned to larger Voronoi cells than media items having a lower prominence level.

In the media map 100, the prominence levels of the media items, and by association, the Voronoi cells representing the media item, are indicated within a square having the identifiers: “L0”, “L1”, and “L2”. In the embodiment shown, the prominence level “L0” is associated with the media item having the highest prominence level, the prominence level “L1” is associated with the media items having the next lower prominence level, and the prominence level “L2” is associated with the media items having a further lower prominence level. Similarly, the Voronoi cells within the media map 100 are of a size corresponding to the prominence level of the media item. For example, the movie “The Godfather” has a prominence level L0 and is assigned to a Voronoi cell 102. Subdivided cells can each respectively represent a child media item of the L0 media item in the hierarchical tree having a prominence level of L1. As such, media items that are siblings in the hierarchical tree are positioned in proximity to one another in the media map 100. The Voronoi cell 102 is subdivided into Voronoi cells such as Voronoi cell 104 being a filler cell, Voronoi cell 110 assigned to a level L1 pseudo node, and Voronoi cell 112 assigned to an L1 child of “The Godfather”. For example, and as depicted in FIG. 1, the Voronoi cells 110 and 112 can be subdivided further into Voronoi cells such as Voronoi cell 106 if the assigned media item has at least one child media item. The further subdivided cells 106 in the Voronoi cell 110 can each, like Voronoi cell 108, respectively represent a child media item of a media item that has an L2 prominence level in the hierarchical tree. In this example, the Voronoi cell 106 is a filler cell.

The media map 100 can be displayed, navigated and edited via one or more user interactions with a user interface, as described in U.S. patent application Ser. No. 14/714,705, of which this application is a continuation application. While the media map 100 depicts movies, in other instances, the media map 100 can be generated for music or images. From the media map 100, a playlist can be generated.

Referring now to FIG. 2, an example environment 200 in which various embodiments can be practiced is shown. In the example environment 200, a media management system 202 is configured to obtain a media map (e.g., media map 100) via a network 204 (e.g., the Internet). The media management system 202, upon obtaining the media map from a media library 206, can generate a playlist within the media map (e.g., media map 100). The media management system 202 can transmit the generated playlist across the network 204 to one or more user display devices 208 for display and subsequent presentation of the media items in the playlist. The user display device 208 can receive an instruction from the user to generate a new playlist or to accept a branching playlist and transmit the instruction over the network 204 to the media management system 202. The media management system 202 can interpret the received instruction, and generate a new playlist accordingly.

The media management system 202 comprises a communication module 210 and a playlist generation module 212. The media management system 202 can be implemented in a variety of ways known to those skilled in the art including, but not limited to, as a computing device having a processor with access to a memory capable of storing executable instructions for performing the functions of the described modules. The computing device can include one or more input and output components, including components for communicating with other computing devices via a network (e.g., the network 204) or other form of communication. The media management system 202 comprises one or more modules embodied in computing logic or executable code such as software.

In some embodiments, the communication module 210 obtains a media map from the media library 206 or from a media map system (e.g., the media map system described in U.S. patent application Ser. No. 14/336,997 filed Jul. 21, 2014, of which this patent application is a continuation) via the network 204. In some instances, the media map system, the client display device 208, and/or the media library 206 can be co-located with the media management system 202. The media management system 202 is configured to receive instructions from a user using the user display device 208 (e.g., via the network 204) to display the media map including one or more playlists and to generate additional playlists. The media management system 202 then executes the instruction and generates the playlists or causes the media items in the playlists to be presented to the user as necessitated by the instruction and as described herein. After the playlist is modified by acceptance of a branching playlist, the communication module 210 can provide a display of the branching playlist to the user display device 208.

The playlist generation module 212 is configured to receive a playlist request. The playlist request can be one of a variety of formats. The playlist generation module 212 then generates an ordered list of media items based on the media map to fulfill the playlist request. The playlist generation module 212 provides the playlist to the communication module 210 which can then present the playlist and/or the media items in the playlist to the user via the user display device 208.

The playlist generation module 212 can perform various methods to fulfill the playlist request. The method performed depends, in part, on the format of the playlist request received from the user of the user display device 208. At least six example methods are discussed herein. Each of these methods begin by obtaining a media map via which an instruction to generate the playlist is received. The generated playlist can be presented to the user as an additional graphical feature of the obtained media map via the user display device 208.

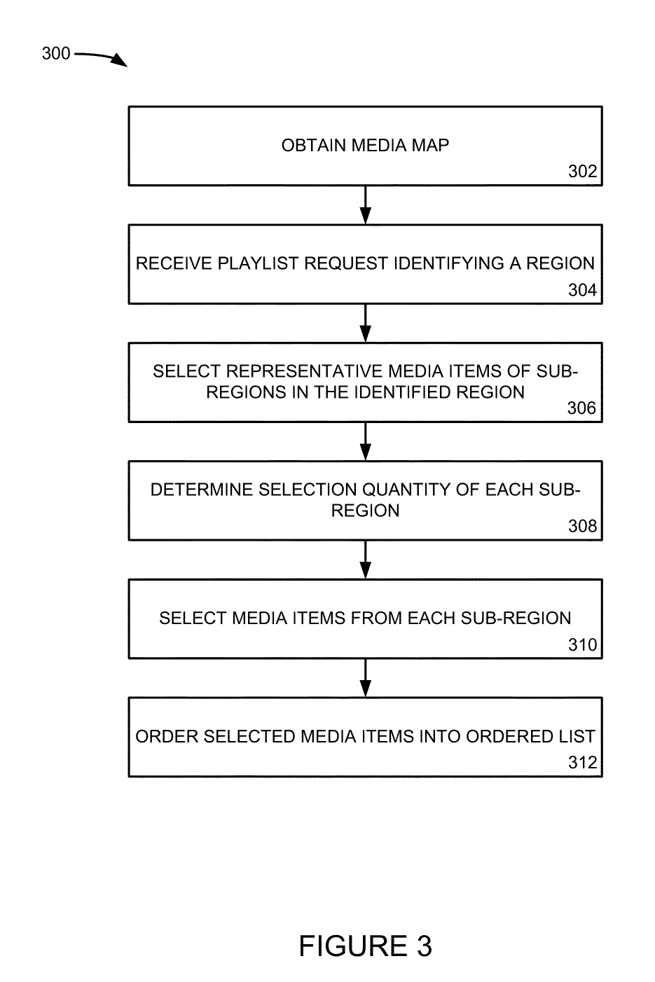

In a first example method, FIG. 3 is a flowchart of an example method 300 for generating a playlist of media items from a region of the media map, according to a first format of a playlist request. The method 300 is performed within a single region (e.g., cluster or sub-cluster) of a media map. The user can select a region by interacting with the label description of the region and the system selects a set of media items within the selected region up to a target size of the requested playlist. In some instances, the target size can be calculated from a pre-defined or a user-defined target playback duration, target number of items, or target percentage of the media items included in the selected region of the media map. A representative selection of the media items within the region is made by selecting a random but representative subset. This sampling can be used for the generation of a playlist as well as a mash-up of preview snippets to represent the selected region, aurally (e.g., song previews), or visually (e.g., video previews). The use of randomness in playlist generation is optional. In the following method and examples, it is assumed that some “randomness” in the generated playlists is a desirable attribute. Therefore, some random selection and sorting can be used, but is not required. The method 300 can be performed by the media management system 202.

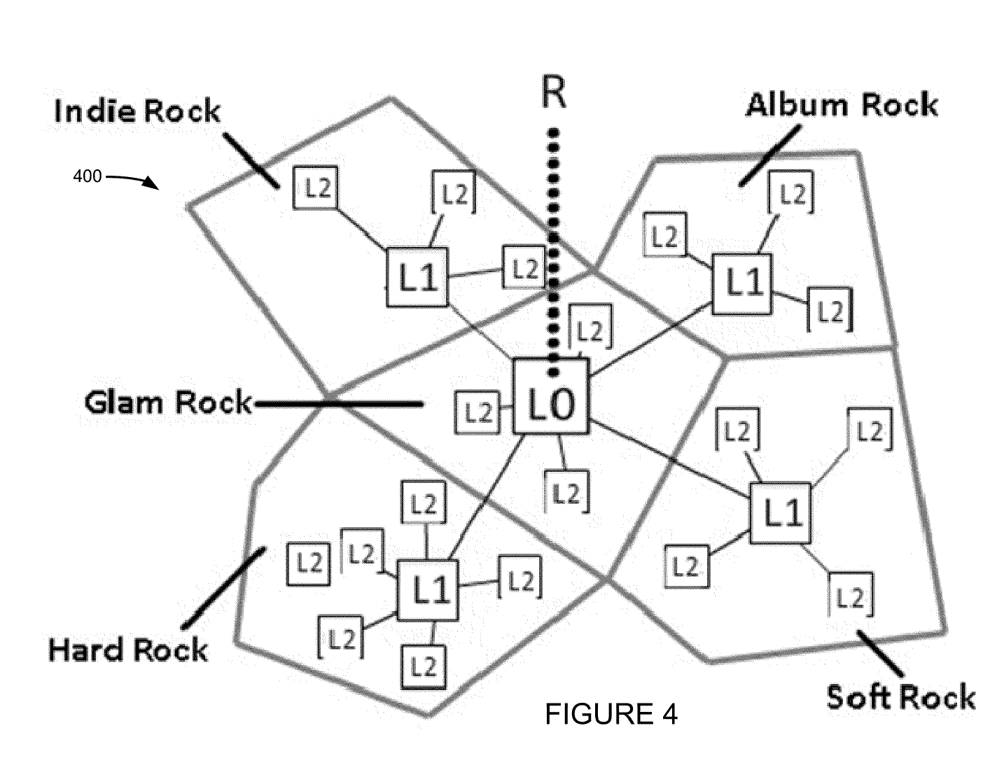

In an operation 302, a media map (e.g., media map 100) is obtained. In some embodiments, the media map is obtained by the communication module 210. The media map can be displayed to the user via the user display device 208. FIG. 4 is an example portion of a region 400 of a media map. The region 400 of the media map includes media map cells corresponding to media items in the genre “Rock”. As depicted, the region 400 includes five subdivisions: Indie Rock, Album Rock, Glam Rock, Hard Rock, and Soft Rock. Each sub-region is represented by a media item of a higher prominence level than the other media items contained in the sub-region. For example, the region Glam Rock has an L0 representative (e.g., “The Jean Genie” by David Bowie), and the remaining sub-regions each have an L1 representative.

In an operation 304, a playlist request is received from the user via the user display device 208. In the method 300, the playlist request includes an instruction that instructs the playlist generation module 212 to generate an ordered list of media items from the media map. In the operation 304, the playlist request includes an identification of a region of the media map that identifies which region or regions of the media map from which to generate the playlist. To request a playlist that includes media items in the region 400, the user can select the region using known user interface techniques such as a gesture or by clicking on the region with a mouse cursor.

As part of the operation 304, values describing the selected region and the desired playlist are gathered. The values can include a prominence level of the selected region (e.g., the prominence level of the media item in the region having the highest prominence relative to the other media items in the selected region); the total number of the media items in the selected region; the target length of the playlist (as a duration, a number of media items, or as a percentage of the items within the selected region). Using the total number of media items in the selected region (N) and the target length of the playlist (T) (expressed as a number of media items), a ratio (F) is calculated as

F=min(1,T/N)

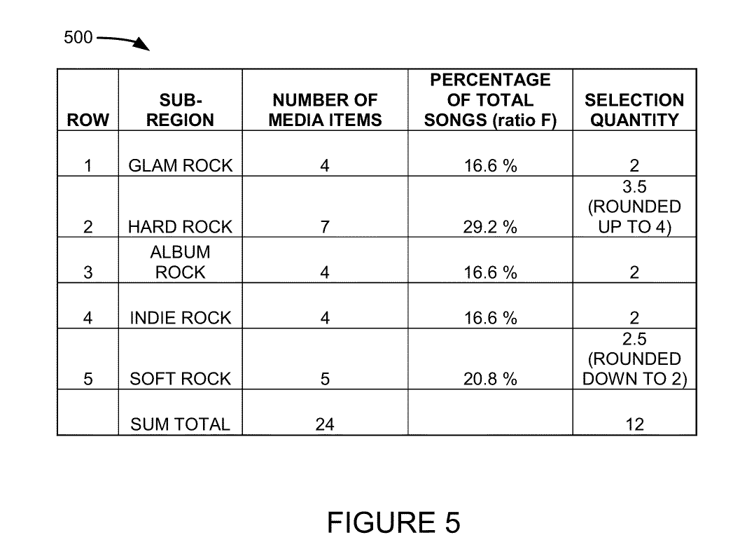

Continuing with the example of FIG. 4, the prominence level of the selected region is prominence level L0 corresponding to the media item “The Jean Genie” by David Bowie. The total number of media items in the selected region 400 is 24 (also listed in the table depicted in FIG. 5, discussed below). The target length of the playlist in this example is set at 12 media items (based, for example, on an average length of the user's listening session).

In an operation 306, the representative media items of the sub-regions within the selected region are selected to be added to the playlist. Referring again to FIG. 4, these are the media items corresponding to the media map cells representing the sub-regions labeled Indie Rock, Album Rock, Glam Rock, Hard Rock, and Soft Rock. These representatives can be randomly sorted.

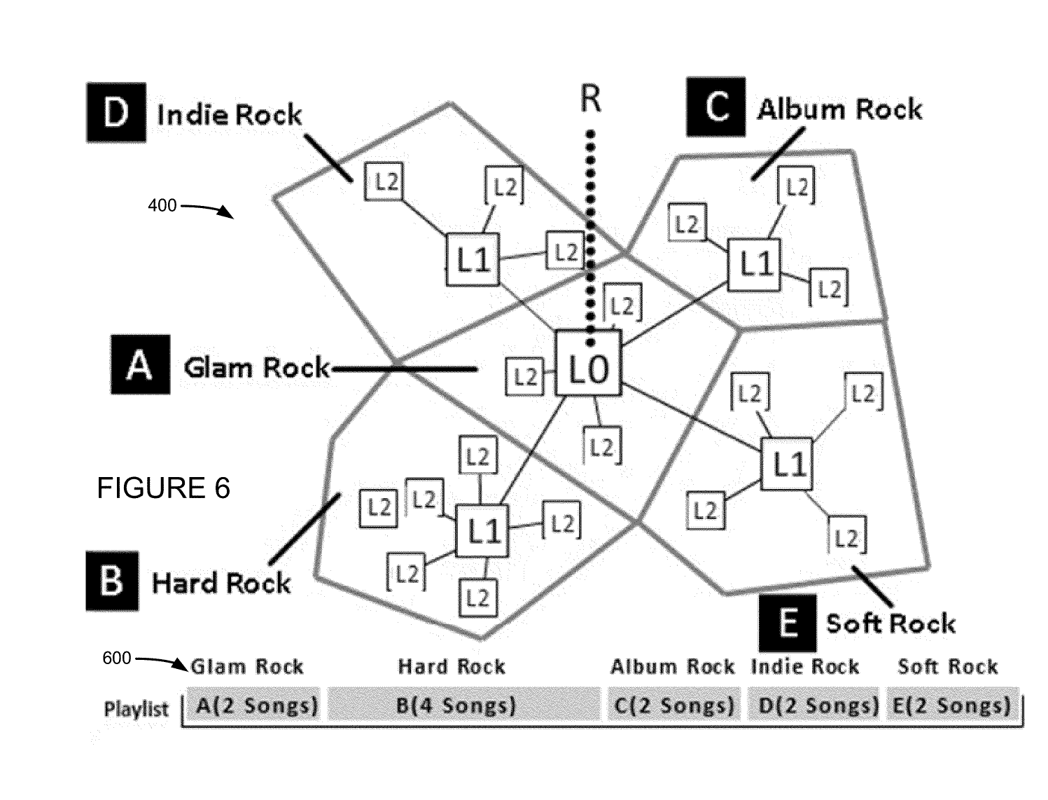

Continuing the example of FIG. 4 based on region 400 of the media map, an order of play between the sub-regions (in the example indicated as A-E with the sub-regions “Glam Rock” (A), “Hard Rock” (B), “Album Rock” (C), “Indie Rock” (D), “Soft Rock” (E)) is determined randomly. In some embodiments, the starting sub-region can be selected according to the metadata tags describing the media items in the sub-region. For example, a sub-region having a highest aggregate score of weighted tags corresponding to the metadata tag “Rock” is selected as the starting sub-region. The ending sub-region in the ordering of the playlist can be determined through the selection of the sub-region that is located farthest from the starting sub-region in the media map. In the example, the songs marked as L1 in each of the sub-regions (“Glam Rock” (A), “Hard Rock” (B), “Album Rock” (C), “Indie Rock” (D), “Soft Rock” (E)) can be selected as the representational element in a playlist 600, as shown in FIG. 6 and as discussed herein.

Referring again to FIG. 3, in an operation 308, to add more media items to the playlist, a selection quantity (e.g., how many or a quantity) to select from each sub-region is determined. The selection quantity of media items to select from each of the sub-regions is based on a ratio F (expressed as a percentage) between a total number of media items in the sub-region and the total number of media items in the region (N). The selection quantity includes one count for the representative media item. FIG. 5 is a table 500 of values used to select songs from sub-regions of the region of the region 400 of the media map. For each sub-region, its percentage of total songs (e.g., the ratio F) is calculated and used to calculate its target percentage in the playlist (in this example, the playlist target length is twelve songs). As depicted in the table 500, if the determined number is not a natural number, it is rounded to the nearest natural number, and then adjusted, such that the sum total of selected media items matches the target length of the playlist. An additional option is to include a requirement that each sub-region is represented in the generated playlist at least once (by, for example, its representative media item). In some embodiments, the operations 306 and 308 can be performed in reverse order, such that the operation 308 is performed before the operation 306 is performed.

Referring again to FIG. 3, in an operation 310, media items are selected from the sub-regions based on the determined number for each sub-region (operation 308). In some embodiments, a random selection from each sub-region is made by randomly sorting the media items within the sub-region and selecting the media items up to the determined number for the sub-region. Hence, selecting twelve songs, proportionally, out of a total of twenty-four, two songs (including its representative media item) are selected from “Glam Rock” out of its population of four, and four songs (including its representative media item) are selected from “Hard Rock” out of its population of eight, and so on for each of the sub-regions so that the playlist includes the five representative media items having prominence level L0 or L1 and seven media items having prominence level L2).

In an operation 312, the selected media items are ordered into a playlist. The ordering can be random, or as depicted in the playlist 600 of FIG. 6, can be based on an ordering of the respective sub-regions within the selected region. To illustrate, in the example of FIG. 6, the resulting playlist begins with songs of “Glam Rock”, and proceeds through “Hard Rock”, “Album Rock”, “Indie Rock”, and “Soft Rock” representing the overarching region “Rock”. The number selected from each of the areas represents the overall distribution of the songs in the different sub-regions relative to the total number of songs in all the sub-regions (as shown in FIG. 5).

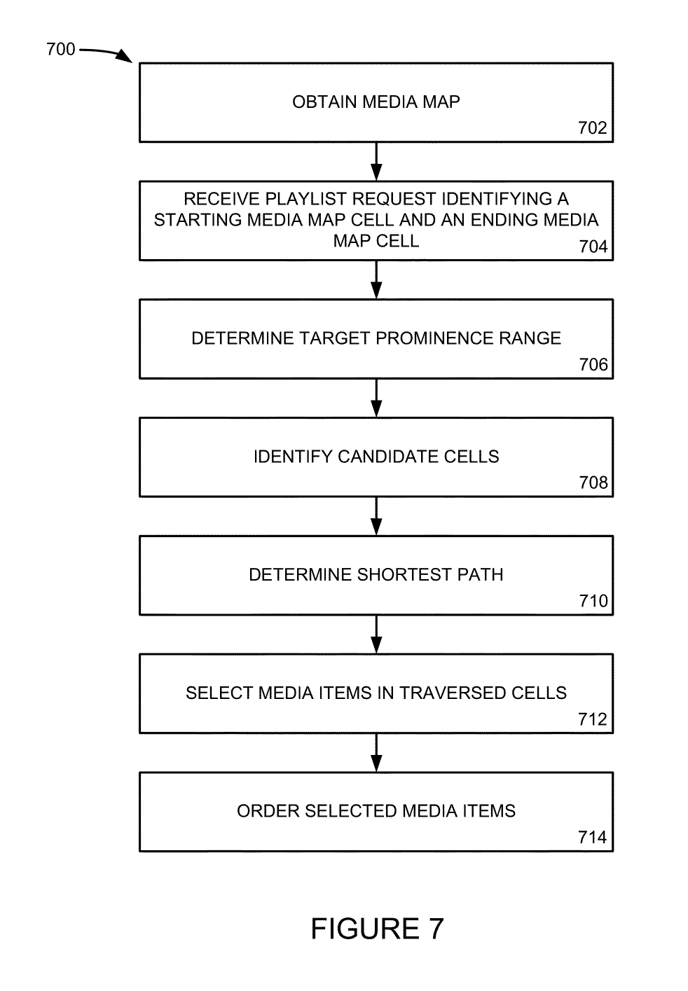

In a second example method, FIG. 7 is a flowchart of an example method 700 for generating a playlist of media items from a startpoint (a first media item) and an endpoint (a second media item) identified on the media map. As explained below, a user can identify, via a graphical user interface at the user display device 208, a media map cell corresponding to a starting media item and a media map cell corresponding to an ending media item. A route from the start to end is determined while accounting for the respective prominence levels of the starting media item and the ending media item, and the spatial distance and arrangement of their corresponding media map cells relative to one another on the media map. A shortest (or targeted length) path is found between the media map cell corresponding to the starting media item and the media map cell corresponding to the ending media item, while staying at the level of the lowest-prominence selected media item. The method 300 can be performed by the media management system 202.

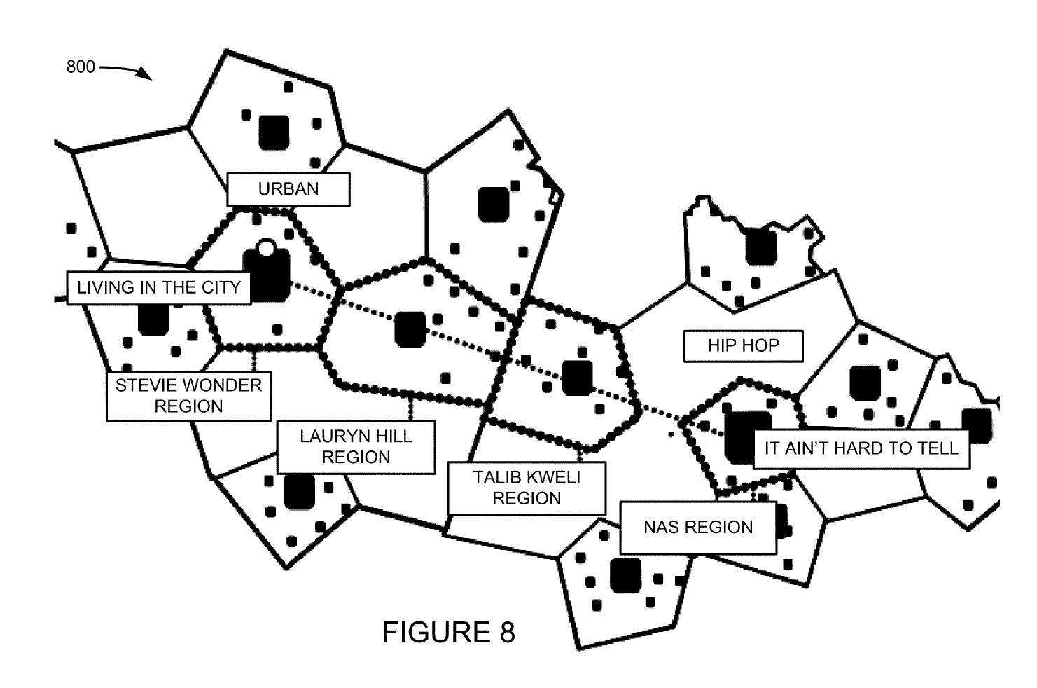

In an operation 702, a media map (or a portion thereof) is obtained. The obtained media map can be provided as a graphical user interface via the user display device 208. An example portion of a region 800 of a media map is shown in FIG. 8.

In an operation 704, a playlist request is received from the user. The playlist request includes an identification of a media map cell corresponding to a starting media item and an identification of a media map cell corresponding to an ending media item. In some instances, the user can select media map cells within the obtained media map that correspond to the user's desired starting media item and ending media item. The starting media item can be designated by the user by virtue of being identified before the ending media item is identified. In other instances, the user can explicitly identify the first media, while the ending media can be selected by the system as explained further elsewhere herein. In other instances, the user can explicitly identify a first media item as the starting media item and a second media item as the ending media item. In the example portion of the region 800 of the media map shown in FIG. 8, a user has identified a starting media item, “Living in the City”, and an ending media item, “It Ain't Hard To Tell”, of a requested playlist.

In an operation 706, a target prominence range is determined. The target prominence range is used to constrain the media items selected for the playlist to those that are of similar prominence as the starting media item and the ending media item. The respective prominence levels of the starting media item and the ending media item are obtained. The range of prominence levels to traverse within the playlist being generated is calculated as:

P=max(Sp,Ep)+n

where P is a lowest level of prominence (i.e., having a highest number in the scheme described in connection with FIG. 1), Sp is the prominence level of the starting media item, Ep is the prominence level of the ending media item, and n is a tunable parameter that controls the number of prominence levels beyond the identified media items which to traverse. In some embodiments, n is set to 2, indicating that the playlist can contain songs that are at the level of the children or grandchildren of the identified media item. In some instances, the tunable parameter n is dictated by the visual representation (e.g., zoom level and/or panned area) of the obtained media map.

Continuing with the example of FIG. 8, where “Living in the City” by “Stevie Wonder” (in the “Urban” region and the “Stevie Wonder” sub-region) is the starting media item. The prominence level of “Living in the City” (Sp) is zero, because it is the most prominent song of that region and the representative of the region. Second, the user selects “It Ain't Hard To Tell” by “Nas” (in the “Hip Hop” region and the “Nas” sub-region) as the ending media item. The prominence level of “It Ain't Hard to Tell” (Ep) is zero, because it is the most prominent song of that region and the representative of the region. As calculated from the prominence levels of the starting media item and the ending media item, the prominence levels to traverse are P<max(Sp, Ep)+2=2 because max(Sp, Ep) is zero. In this example, the playlist can include media items having a prominence level of L0, L1, and L2, which includes the media items shown in FIG. 8.

In an operation 708, candidate cells are identified. The candidate cells are those that are located between the media map cells corresponding to the starting media item and the ending media item, respectively. Further, the identification of the candidate cells is constrained to those within the target prominence range (e.g., those cells having a prominence level that is less than or equal to P, calculated above). As shown in FIG. 8, candidate cells are detected for each of the successive neighboring cell from the “Stevie Wonder” region towards the “Nas” region, including the “Stevie Wonder” and “Nas” region itself, these are additionally the “Lauryn Hill” and the neighboring “Talib Kweli” regions.

In an operation 710, media items are selected from each of the traversed candidate cells by calculating a shortest path. Various shortest path algorithms are known to those skilled in the art. If the shortest path algorithm does not select enough media items to meet a target length of the playlist, the method 300 of FIG. 3 can be performed to identify additional media items in the same region as the traversed candidate cells. In an operation 712, the selected media items are ordered according to the path between the starting media item and the ending media item.

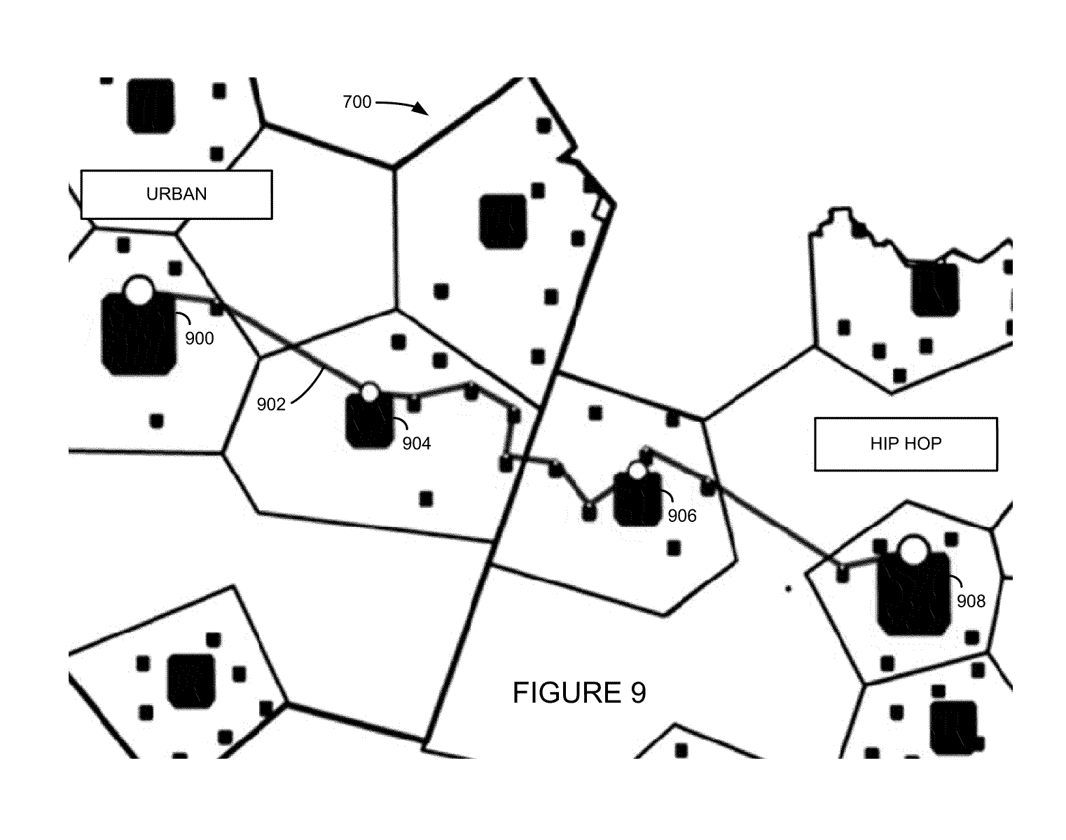

As depicted in FIG. 9, the operation 710 results in a playlist 902 beginning at a starting media item 900 and ending at an ending media item 908. The playlist 900 has media items including “Living in the City” by “Stevie Wonder” (e.g., the starting media item 900), “Every Ghetto, Every City” by “Lauryn Hill” (e.g., a second media item 904), “Back up of me” by “Talib Kweli” (e.g., a third media item 906), and “It Ain't Hard To Tell” by “Nas” (e.g., the ending media item 908).

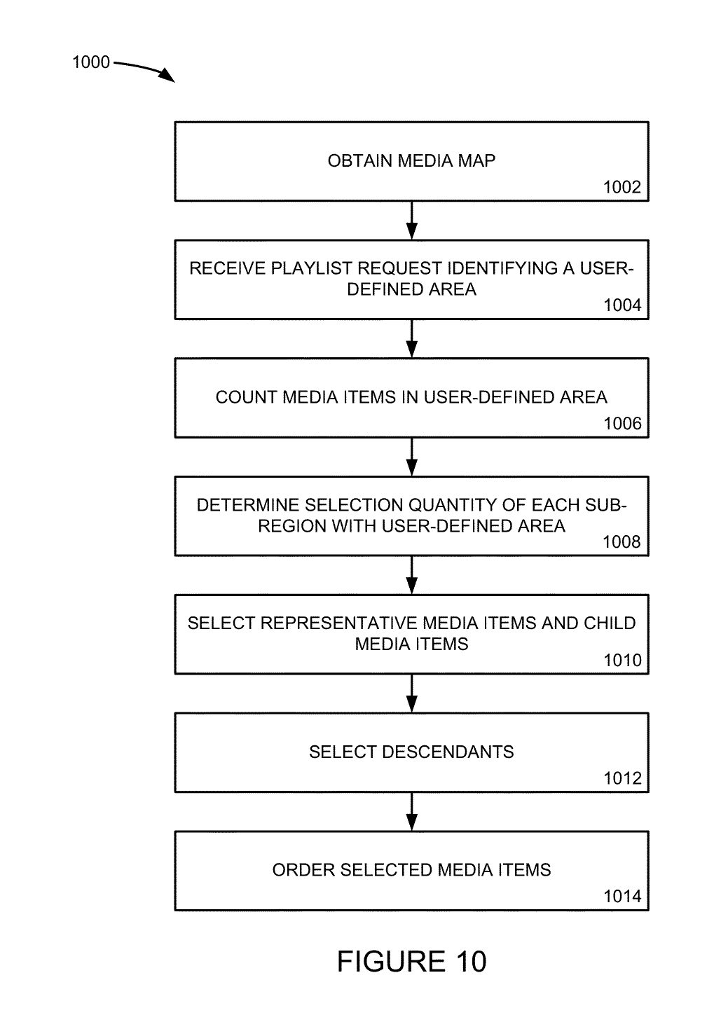

In a third example method, FIG. 10 is a flowchart of an example method 1000 for generating a playlist of media items from a user-defined area of an obtained media map. In some embodiments, the user defines the area by indicating a circular or other enclosed shape on a media map displayed by the user display device 208. The user can select the desired area of the media map by selecting the size of a circle (or other enclosed shape) from a representation depicting an approximate center of the enclosed shape. The media items which are in the range of the defined area(s) are identified. The defined area can be used for the generation of a playlist as well as a mash-up of preview snippets to represent the defined area aurally (song previews) or visually (video previews). The method 1000 can be performed by the media management system 202.

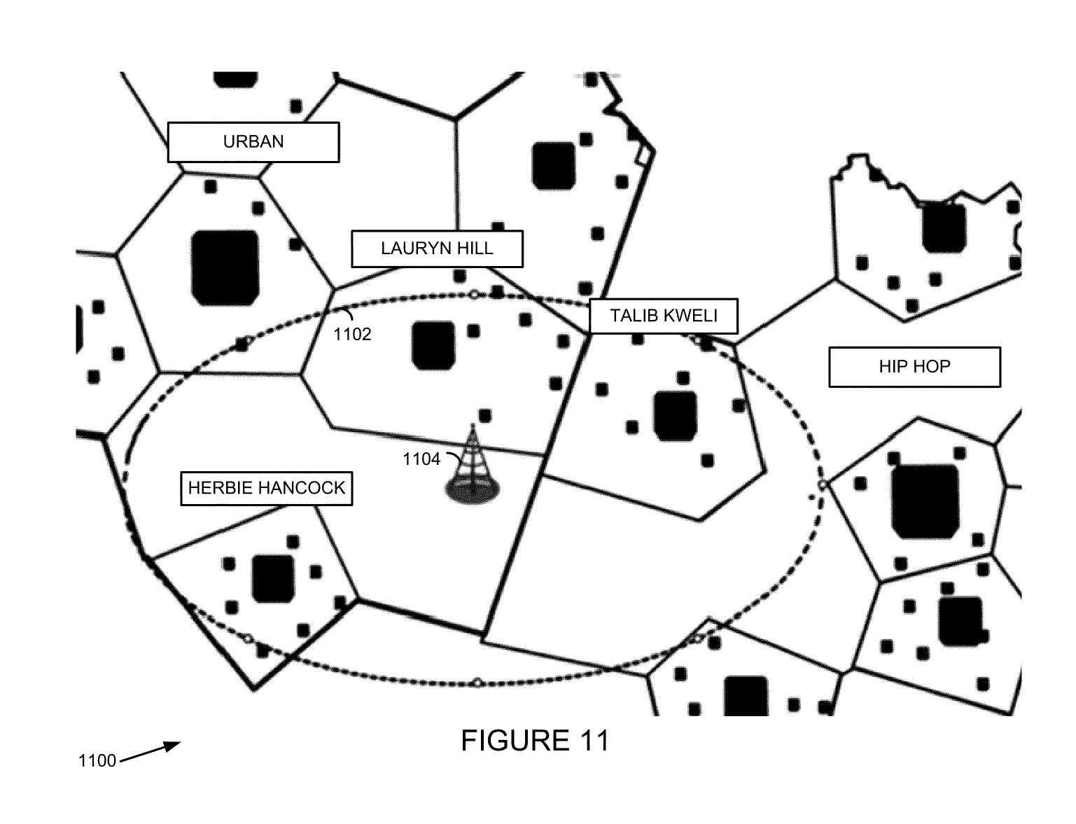

In an operation 1002, a media map, or portion thereof, is obtained. The media map can be obtained by, for example, the communication module 210. FIG. 11 is an example portion of a region 1100 of a media map.

In an operation 1004, a playlist request identifying a user-defined area of the media map is received. The user-defined area has an enclosed shape that encompasses one or more sub-regions and/or portions of sub-regions within the obtained media map. The playlist to be generated includes media items corresponding to the media map cells that are at least partially within the enclosed shape.

FIG. 11 is an example portion of a region 1100 of the media map depicting a playlist request that specifies a user-defined area of the region. In the embodiment shown in FIG. 11, the user requests the playlist by selecting the size of a circle 1102 (the circle 1102 appears oval-shaped or elliptical due to the display used to generate the media map of FIG. 11) extending at a radial distance from a centerpoint of the circle (represented by the radio tower 1104). In an alternative embodiment, the user selects a displayed graphic as the centerpoint of the circle (e.g., by clicking on a displayed graphic such as a radio tower) where the circle has pre-defined fixed or a user-manipulable radius. In other embodiments, using known user interface techniques, the user can draw or manipulate other enclosed shapes to define the area and therefore the area need not be limited to being circular.

In an operation 1006, the media items within the user-defined area are counted. Media items that appear to be fully within the user-defined area are included. Media items that appear to overlap the border of the user-defined area or are outside of the user-defined area are not included, even if other media items within the same sub-region are within the user-defined area. For example, in the “Lauren Hill” sub-region of FIG. 11, the uppermost media items in the region that are not enclosed within the user-defined area 1102 are not included in the total number calculated on the operation 1006.

In an operation 1008, a selection quantity of media items to select from each sub-region within the user-defined area is determined. The operation 1008 uses the total number of media items calculated in the operation 1006. Like the operation 308 of FIG. 3, a proportional number of media items from each sub-region is determined using the equation for ratio F, as described above.

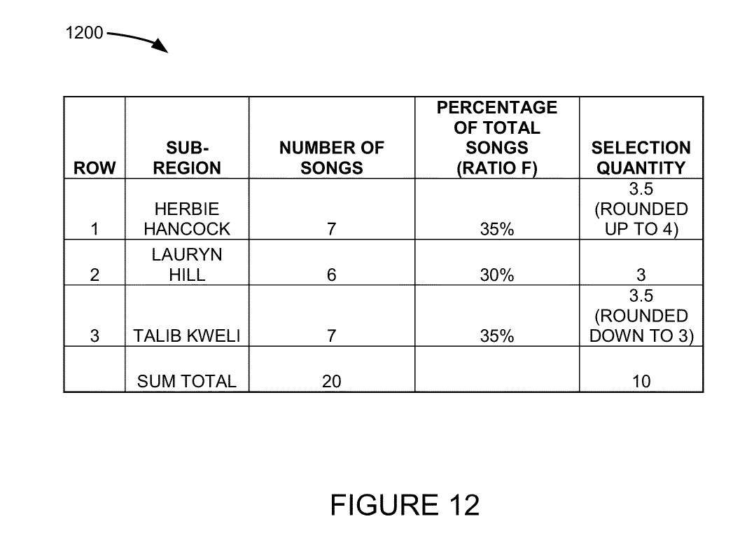

Referring to FIG. 12, a table 1200 lists the three sub-regions of FIG. 11 that each have at least one media map cell corresponding to a media item within the user-defined area. The table 1200 includes only those media items that are within the user-defined area. To illustrate, according to the table 1200, the sub-region labelled “Herbie Hancock” has seven songs. According to FIG. 11, the same sub-region has eight songs total but only seven songs within the circle 1102. Likewise, the sub-region “Lauryn Hill” is listed as having six songs even though the sub-region “Lauryn Hill” in FIG. 11 has eight media items; the remaining two media items are not within the circle 1102. The sub-region “Talib Kweli” is listed as having seven songs even though the sub-region “Talib Kweli” in FIG. 11 has eight media items; the remaining media item is not within the circle 1102.

The selection quantity to select from each sub-region is determined proportionally across the sub-regions included in the user-defined area. As described in connection with FIG. 3, the selection quantity is determined to be a natural number. Rounding can be performed in instances involving fractions. The determined numbers can be adjusted based on the target length of the playlist.

Referring again to FIG. 10, in an operation 1010, representative media items and child media items of the sub-regions included in the user-defined area are selected to be added to the playlist. The representative media items are identified by having a higher prominence level than the other media items in the sub-region. The child media items are identified by having a prominence level that is one level lower than that of its respective representative media item in the sub-region.

In an operation 1012, descendants of the representative media items and their child media items are selected. As described in the operation 310 of FIG. 3, this set is calculated by randomly sorting a list of descendants D (e.g., children and children of children). Then, the product of the ratio F and the length of the list of descendants D is used to determine a number of descendants to select. That number is descendants, beginning at the top of the list of descendants, are then selected to be added to the playlist after their respective representative media item.

In an operation 1014, the selected media items are ordered into a playlist, as described in connection with operation 312. In some instances, the selected media items are ordered by sub-region, as shown in FIG. 6.

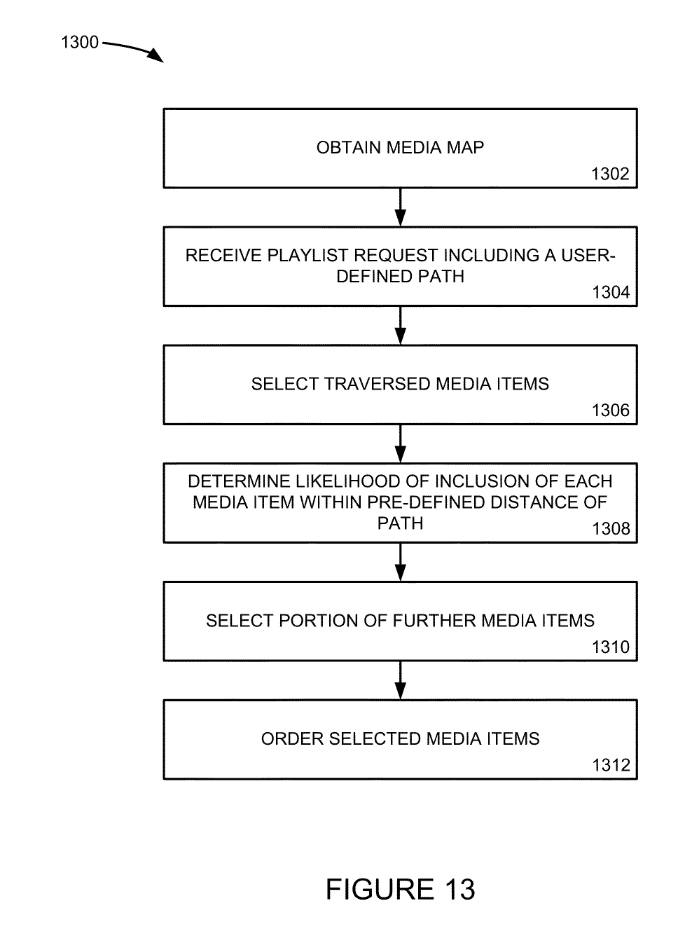

In a fourth example method, FIG. 13 is a flowchart of an example method 1300 for generating a playlist of media items from a user-defined path traversing the media map. The user can generate a playlist request by drawing a path on the media map using the user display device 208. Media items corresponding to media map cells proximate to the user-defined path are selected. Only the items that are visible to the user at that specific zoom level and that have a minimum distance between each other are selected. The generated playlist conforms to the perception of the user at that zoom level in which a specific set of media items is shown based on their respective prominence level(s). A minimum distance requirement can be implemented to reduce the number of songs selected from one sub-region, so that when the user draws over an especially dense sub-region (e.g., a sub-region containing a significant number of media map cells corresponding to media items), a proportionally large number of songs are not selected from that sub-region, allowing more media items to be selected from other sub-regions traversed by the user-defined path. The method 1300 can be performed by the media management system 202

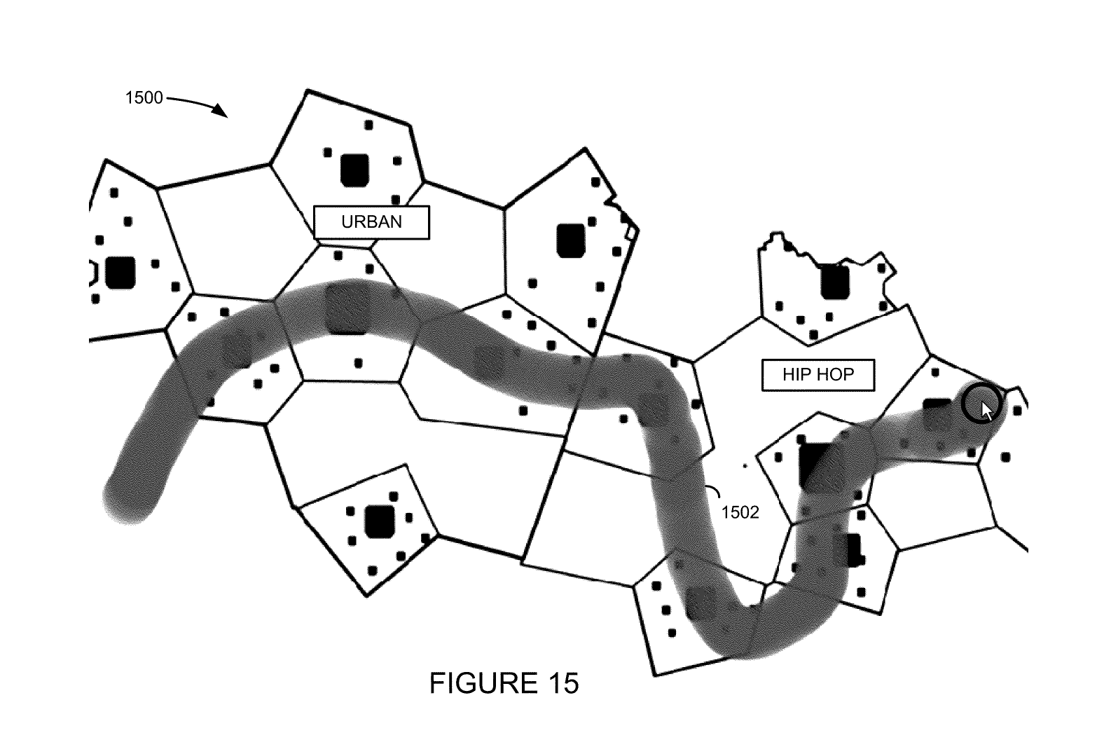

In an operation 1302, a media map, or portion thereof, is obtained. The media map can be obtained by the communication module 210. FIG. 15 depicts an example portion of a region 1500 of a media map.

In an operation 1304, a playlist request including a user-defined path is received. The playlist request can be received from the user display device 208. To allow the user to provide the user-defined path, the user display device 208 can have a touchscreen input mechanism or other known user interface facility. The user-defined path traverses one or more regions or sub-regions of the displayed portion of the media map.

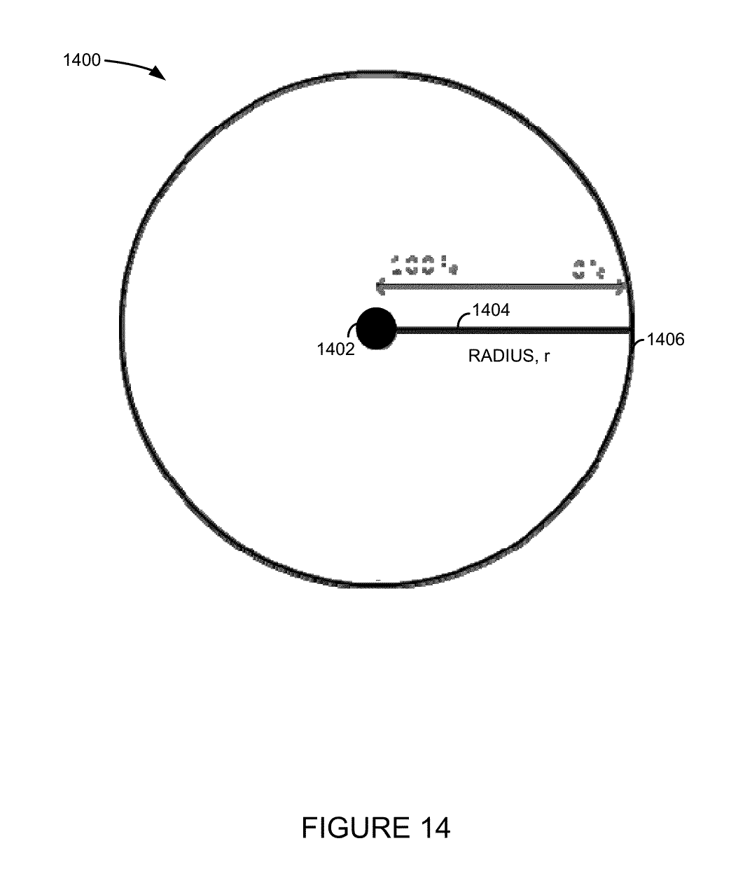

FIG. 14 is a diagram of a user interface input mechanism to request a playlist by allowing the user to draw a path through a region of the media map. While drawing and in one embodiment at a fixed periodic rate, a virtual drawing circle 1406 with a radius r is created around a touch point 1402 of the user. Media items that are visible on the media map at the current zoom level and within the drawing circle 1406 can be selected for the playlist based on their respective distances from the touch point 1402. When the user draws over a sub-region more slowly, the chance of the respective media items within the drawing circle 1406 being included in the playlist increases because multiple drawing circles can be generated over time and within the same sub-region. The user can therefor instruct that more media items from the specific sub-region be added to the playlist

FIG. 15 depicts a portion of a region 1500 of the media map in which a user has requested a playlist by drawing a path. As depicted, the user has drawn a path 1502 from left to right across the region 1500. The path 1502 is depicted as a line having a line width of the diameter of the drawing circle 1406. However, the path 1502 can be displayed to the user in other ways, for example, as a line of a different thickness or of a varying thickness. The path 1502 can be drawn by the user via a gesture or another input mechanism, such as by moving a mouse cursor across a display.

Returning to FIG. 13, in an operation 1306, the media items corresponding to the media map cells traversed by the touch point 1402 of the user are selected. As depicted in FIG. 14, the media items corresponding to the media map cells that are traversed by the touch point 1402 have a 100% likelihood of inclusion in the playlist. These media items are the first to be added to the playlist.

In an operation 1308, a likelihood of inclusion of each media item proximate to the touch point 1402 is determined. The likelihood of inclusion is based on a distance of a corresponding media map cell to the touch point 1402, up to a pre-defined maximum, expressed as the radius r 1404 in FIG. 14. In some instances, particularly if the user gestures slowly, the same media map cell can be associated with two or more likelihoods of inclusion based on sequential captures of the touch point 1402 at sequential points in time. For example, at a time of a first capture, the media map cell may be “ahead” of the touch point 1402 and have a lower likelihood of inclusion; at a time of a second capture, the media map cell may be “alongside” the touch point 1402 and have a higher likelihood of inclusion; and, at a time of a third capture, the media map cell may be “behind” the touch point 1402, resulting in a third and lower likelihood of inclusion. Thus, in this example, the media item corresponding to the media map cell can have three likelihoods of inclusion. These likelihoods of inclusion can be aggregated into a single, higher, likelihood of inclusion using techniques known to those skilled in the art.

In an operation 1310, a further portion of the media items are selected based on the likelihood of inclusion determined in the operation 1308. Based on the user-defined path 1502 and the radius r 1404 around the exact drawing path, additional media items, which are visible to the user at a present zoom level and have a minimum spatial distance between each other at the present zoom level, can be selected for inclusion in the playlist.

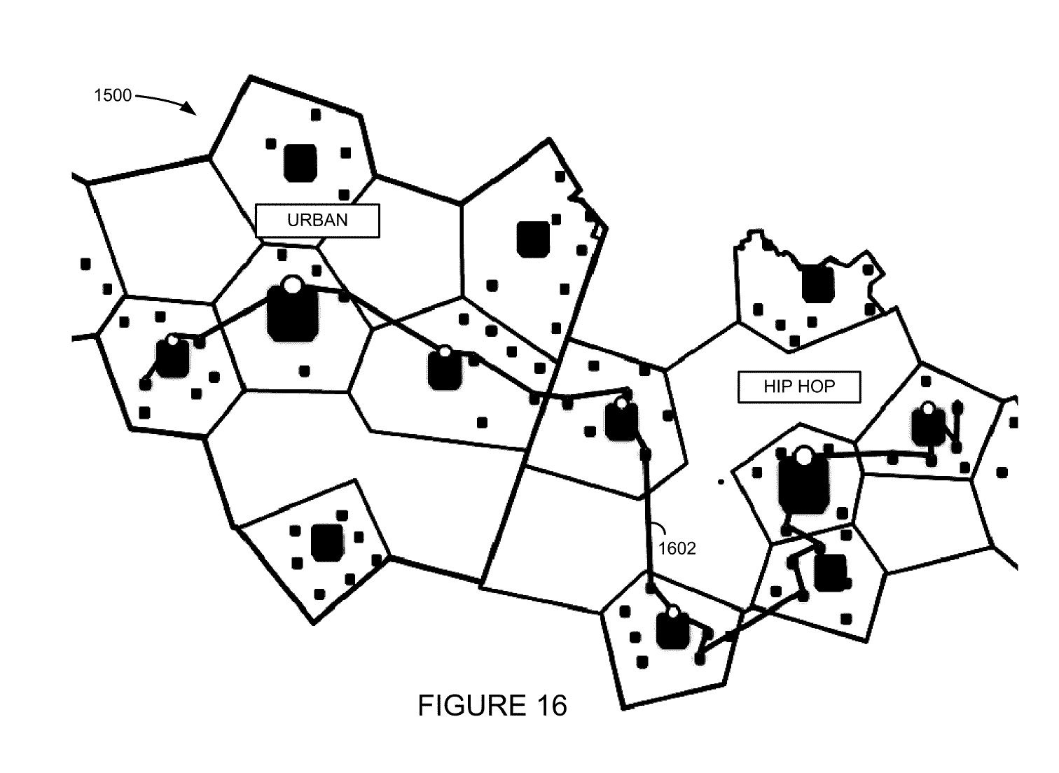

In an operation 1312, the selected media items are ordered according to the direction of the path (e.g., path 1502) received in the operation 1304. FIG. 16 is an example portion of the region of the media map 1500 and depicting a playlist 1602 generated from the user-drawn path according to the method 1300.

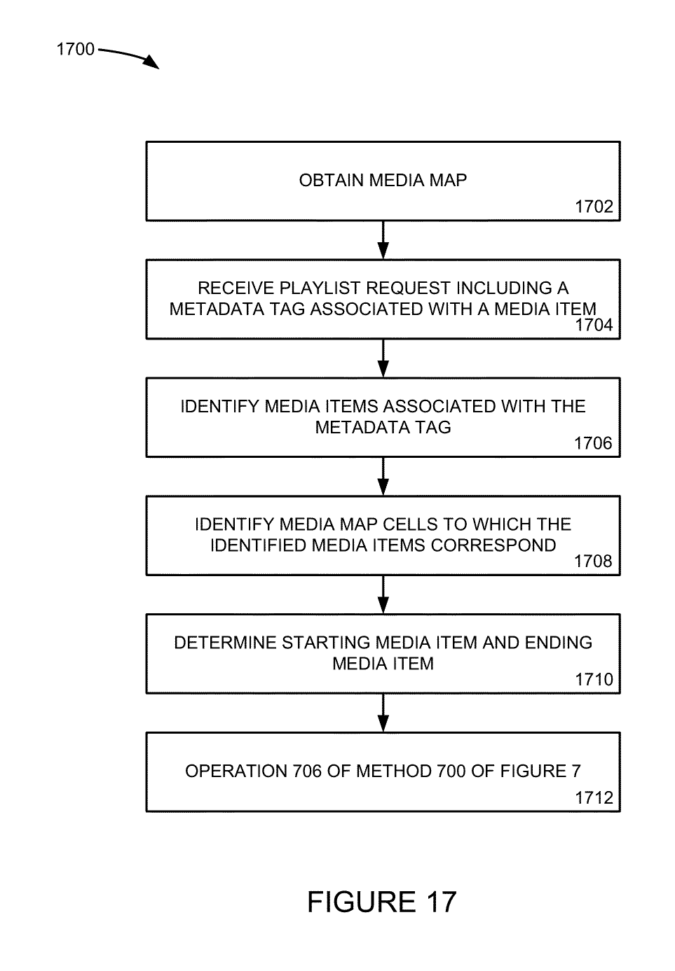

In a fifth example method, FIG. 17 is a flowchart of an example method 1700 for generating a playlist of media items from a selected metadata tag. In some embodiments, the user can explicitly select a metadata tag associated with a media item. In other embodiments, a metadata tag can be selected from those associated with a media item that is currently being played or displayed to the user. The metadata tags of the media items are collected from third party sources, such as Wikipedia, Echonest, and Rovi, as well as assignment by the user of a metadata tag to a media item. The method 1700 can be performed by the media management system 202.

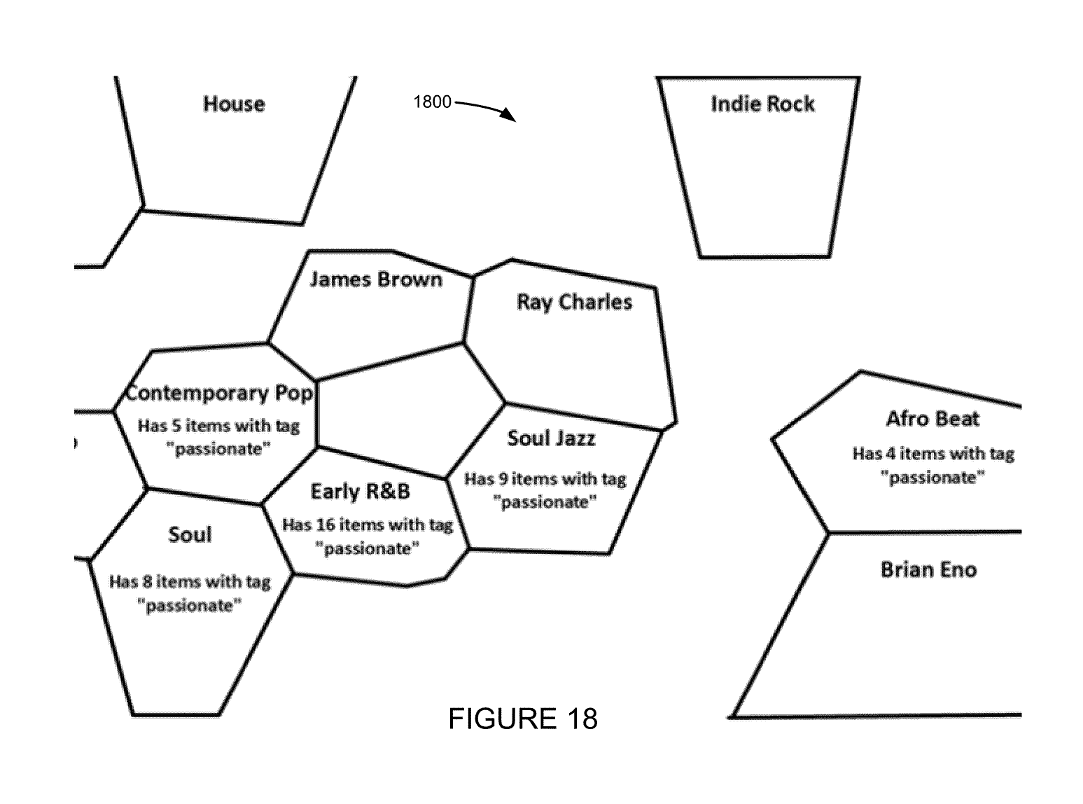

In an operation 1702, a media map, or portion thereof, is obtained. The media map can be obtained by the communication module 210. FIG. 18 is an example portion of a region 1800 of a media map.

In an optional operation 1704, a playlist request including an identification of a currently presented media item or of a metadata tag associated with a media item is received. The playlist request can be explicitly generated by the user via a user interface at the user display device 208. In other instances, the media item from which the metadata tag is identified can be a currently presented media item or a media item selected by the user. In some embodiments, the user can select a metadata tag without necessarily selecting or playing a media item.

In an operation 1706, the sub-regions within the media map having corresponding media items associated with the selected metadata tag are identified. For example, FIG. 18 depicts a simplified version of a portion 1800 of a media map indicating a quantity of media items tagged with the metadata tag “passionate” within each sub-region. In FIG. 18, the sub-regions labelled “Afro Beat”, “Soul Jazz”, “Early R&B”, “Soul” and “Contemporary Pop” each have at least one corresponding media item associated with the tag “passionate”.

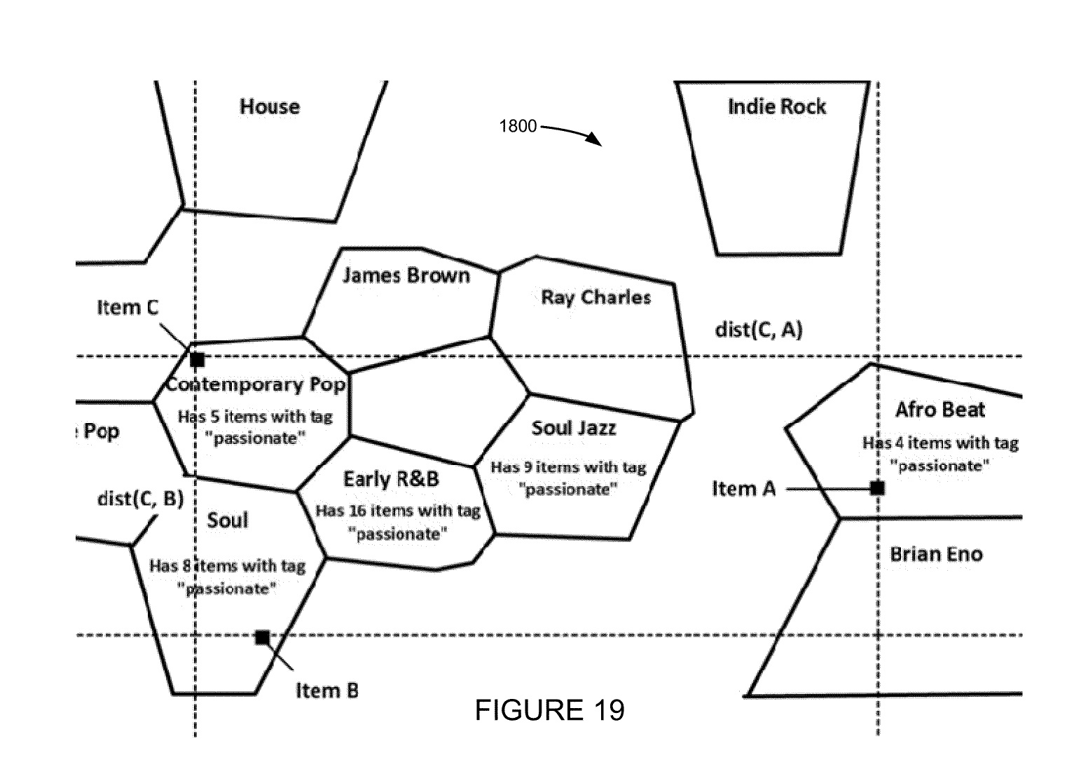

In an operation 1708, the media map cells within the identified sub-regions of the operation 1706 which correspond to media items tagged with the selected metadata tag are identified. As depicted in FIG. 19, three media map cells corresponding respectively to “Item A”, “Item B”, and “Item C” are highlighted.

In an operation 1710, a starting media item and an ending media item are determined based the relative position of the sub-regions identified in the operation 1706. The sub-regions corresponding to the identified media items having the selected metadata tag are analyzed to determine an overall orientation of the playlist. In some embodiments, a first determination is made to measure how far the media map cells corresponding to the identified media items deviate from a line running from the right-most item to the left-most item. This determination can be repeated for the top-most and bottom-most identified media map cells. Based on these determinations, the farthest-right or farthest-top item is selected as the starting media item of the playlist, and the farthest-left or farthest-bottom media item is selected as the ending media item of the playlist. In other embodiments, the user selects the starting media item and the farthest-away media item with the selected metadata tag is determined and used as the ending media item of the playlist.

As depicted in FIG. 19, a horizontal line labelled “dist(C,A)” indicates the horizontal distance between the leftmost identified media item (Item C) and the rightmost identified media item (Item A) in the region 1800 of the media map. A vertical line labelled “dist(C,B)” indicates the vertical distance between the topmost identified media item (Item C) and the bottommost identified media item (Item B) in the region 1800. Because the horizontal line labelled “dist(C,A)” is significantly longer than the vertical line labelled “dist(C,B)”, a determination is made that the overall orientation of the identified sub-regions that contain media items associated with the metadata tag “passionate” is mainly horizontal rather than vertical. As such, a left-to-right or right-to-left order for the playlist is selected. In some instances, the order is further selected based on the sub-region that is farthest away from the center of the region 1800 of the media. In the example of FIG. 19, the sub-region labelled “Afro-Beat”is the farthest away sub-region from the center of the region 1800 and thus is selected as containing the starting media item and the direction of the playlist is set to right-to-left.

To select the starting media item from the starting sub-region, the farthest away song from the center of the region 1800 of the media map positioned within the “Afro-Beat” sub-region and which has the tag “passionate” associated with it is identified. The horizontal distance between the right-most item with the tag “passionate” (Item A) and the left-most item with the tag “passionate” (Item C) is measured, resulting in a distance (dist(C, A)). The vertical distance between the top-most item with the tag “passionate” (Item C) and the bottom-most item with the tag “passionate” (Item B) is measured, resulting in a distance (dist(C,B)). Because the horizontal distance is longer than the vertical distance, the horizontal orientation is selected for the playlist. The right-most media item is selected as the starting media item (media item A, which is part of the “Afro Beat” sub-region). The left-most item is selected as the ending media item (Item C, which is part of the “Contemporary Pop” region).

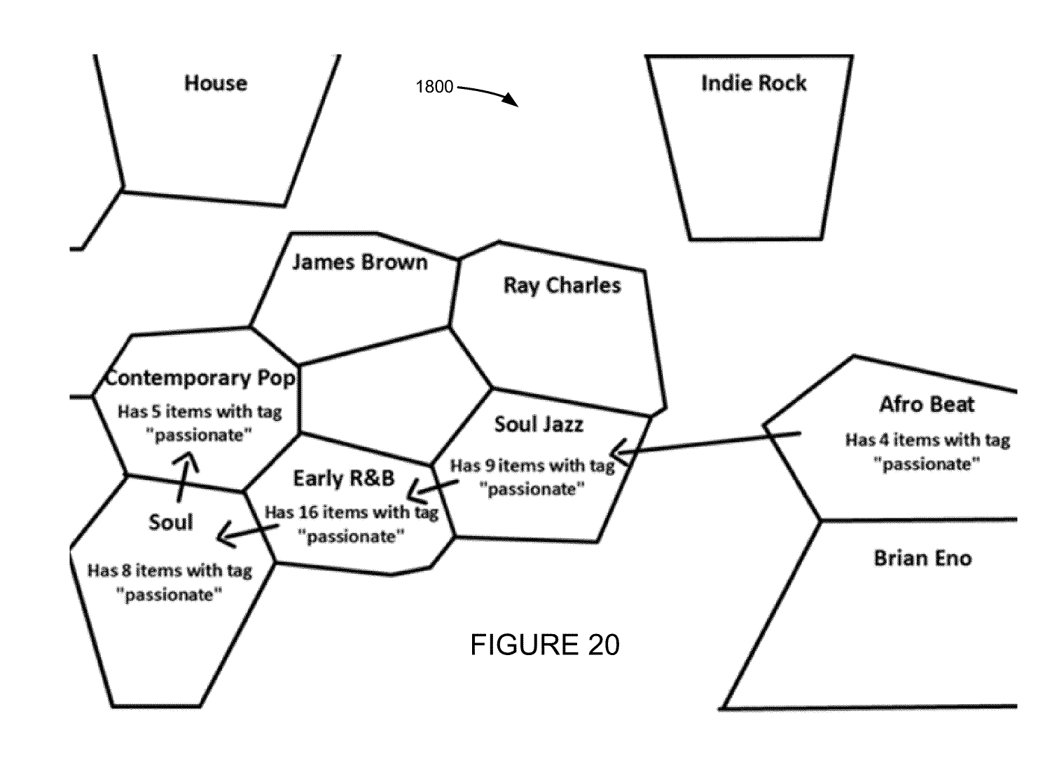

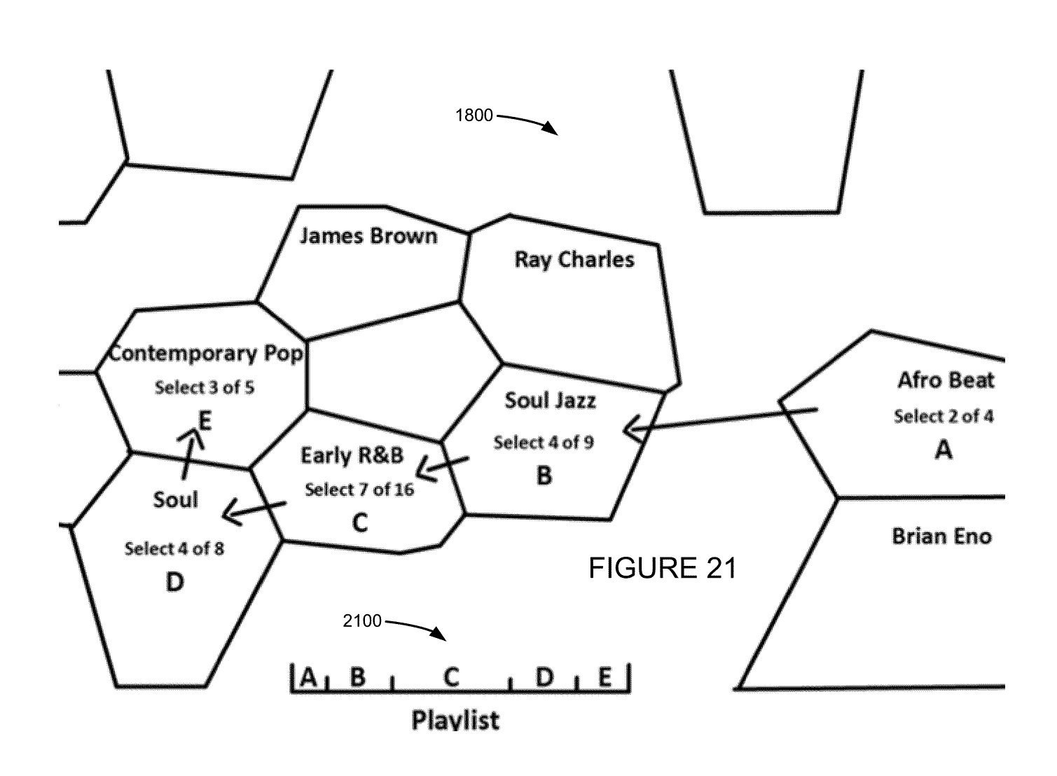

Once the starting media item and the ending media item are selected, the method 1700 proceeds to the operation 706 of the method 700 of FIG. 7. FIG. 20 depicts the simplified version of the region 1800 of the media map depicting an example path through the region generated using method 700. FIG. 21 depicts the simplified version of the region 1800 of the media map and indicates a number of media items to select from each of the travelled sub-regions in a playlist 2100, as described in connection with the method 700.

In some instances, the method 1700 can be used to generate a new playlist that branches from a current media item that is currently playing or selected by the user. The new playlist can be explicitly requested by the user or can be generated automatically by the media management system 202. The new playlist can be accepted by the user, changing which of the media items are subsequently played or displayed by the user display device 208. The new playlist is referred to herein as a “branch” or as a “branching playlist”.

Branching playlists can be generated when the media items corresponding to media map cells in the media map have metadata tags that are each associated with a weight. The weight of the metadata tag can be represented as a percentage, such that a higher percentage indicates a heavier weight. For example, a media item can be assigned the metadata tags: “‘Indie Rock’ (60%)” and “‘Experimental Rock’ (40%)” where the percentage is the weight of the metadata tag for that media item. If there is no weight directly associated with the tags, the tags can be evenly weighted (for example, “‘Indie Rock’ (50%)” and “‘Experimental Rock’ (50%)”).

To generate a branching playlist, the metadata tags associated to the current media item are accessed. If the playlist was generated according to the method 1700 of FIG. 17, the metadata tag used to generate a current playlist is excluded. One of the remaining metadata tags is selected and used to generate a branching playlist according to the method 1700. To select the metadata tag, the weights of the respective tags are used as a probability of the tag being selected (i.e. “Indie Rock” 60%, “Experimental Rock” 40%). If the user does not react to (e.g., explicitly accept or explicitly reject using known user interface techniques) the suggestion, a different branching playlist is generated using a lesser-weighted metadata tag associated with the current media item after a pre-defined time period (e.g., 30 seconds).

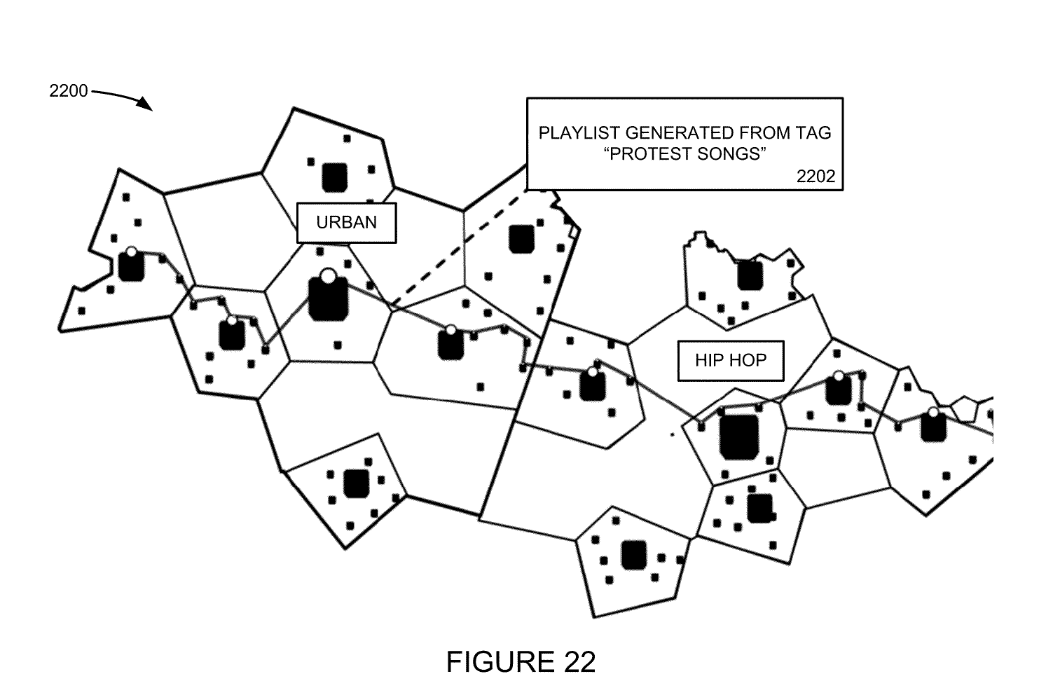

FIG. 22 depicts an example portion 2200 of a media map depicting a previously generated playlist 2202. The previously generated playlist 2202 includes one or more songs that are presently being played to the user by the user display device 208. In this example, the user is currently listening to the song on the playlist 2202 (based on the metadata tag “Protest Songs”). In this instance, the user is currently listening to the song “Zombie” by “Fela Kuti”, which is associated with the metadata tags “Protest Songs” (weight 40%), “African” (weight 35%) and “Social Issues” (weight 25%).

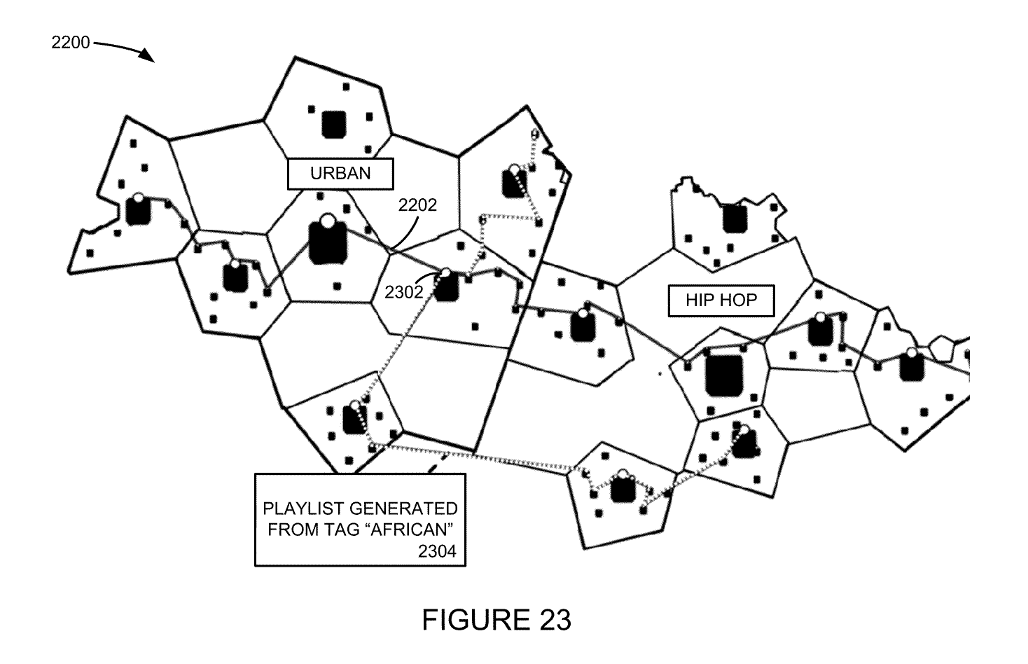

After some time has elapsed, a branching playlist is suggested based on the tags of the currently playing song. Since the media items of playlist 2202 (based on the metadata tag “Protest Songs”) are being presented to the user via the user display device 208, only the two other metadata tags of the song can be used to generate branching playlists, namely, “African” and “Social Issues”. Based on the tag weight of those metadata tags, “African” has the probability of 58.3% (35%/60%) to be chosen and the metadata tag “Social Issues” has a probability of 41.7% (25%/60%) to be chosen. In the example, the metadata tag “African” is selected. A branching playlist based on the metadata tag “African” is generated according to the method 1700, discussed above. FIG. 23 depicts the example portion 2200 of the media map and a first branching playlist 2304 that branches at the current media item 2302.

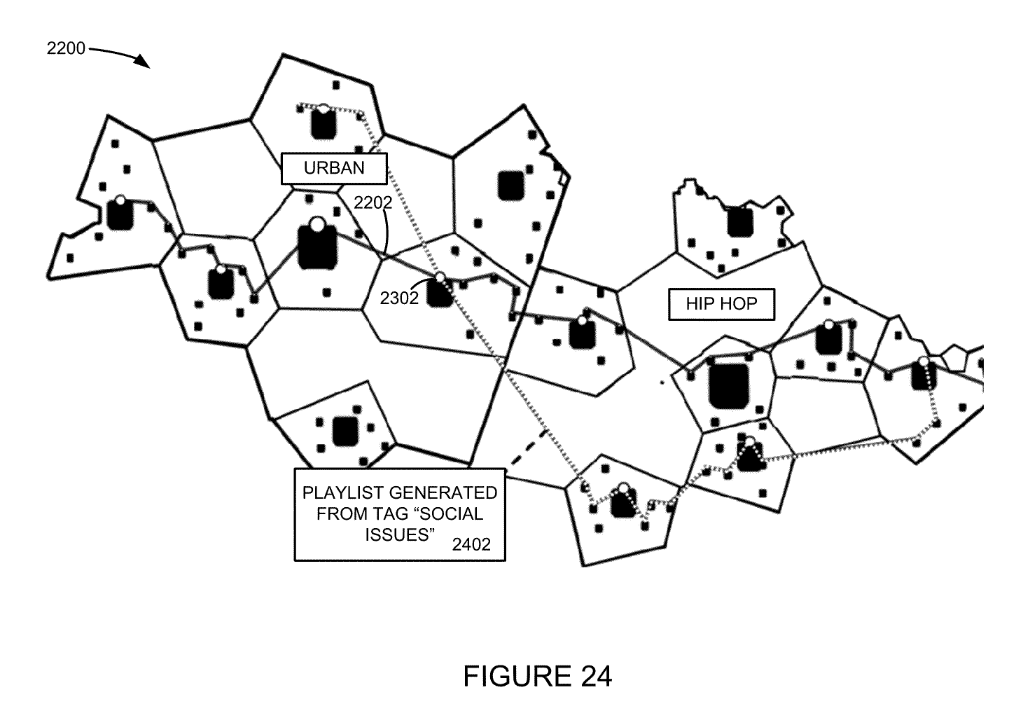

If the user has not accepted the branching playlist, another branching playlist is generated using another metadata tag associated with the current media item 2302. Since both of the metadata tags “Protest Songs” (from which the current playlist was generated) and “African” (already suggested) are already excluded from the potential metadata tags that can be used to generate a branching playlist, the remaining metadata tag associated with the current media item, “Social Issues”, has a 100% chance to be selected next and is used to generate a further branching playlist according to the method 1700 of FIG. 17. FIG. 24 depicts the example portion 2200 of the media map and a second branching playlist 2402.

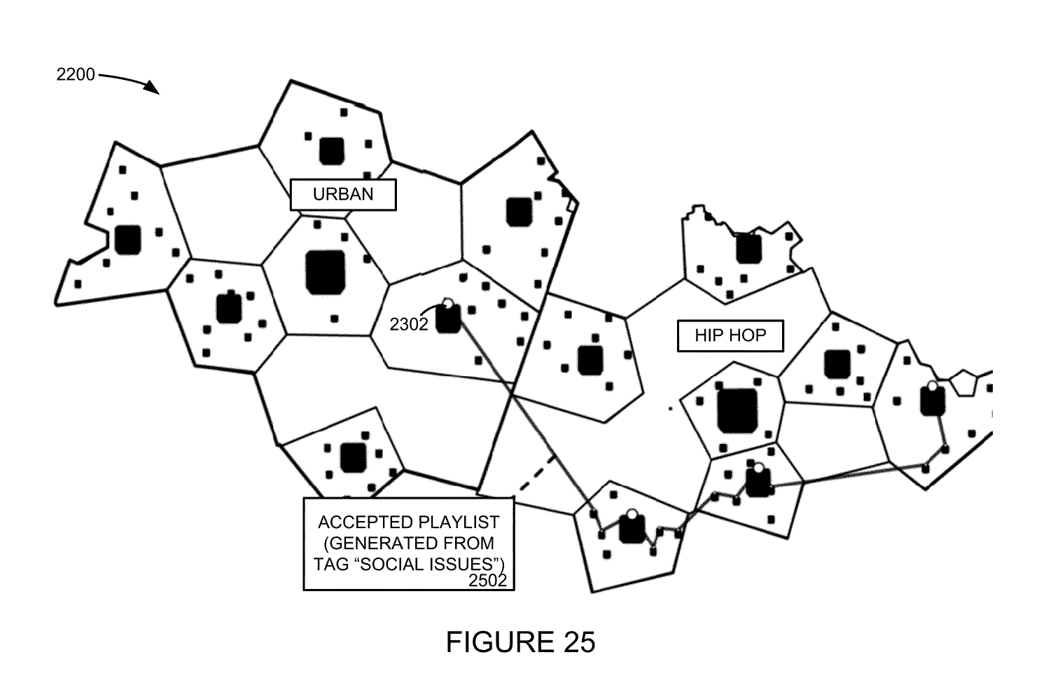

In the example, the user accepts the branching playlist 2402 based on the tag “Social Issues”. Once the current media item 2302 has finished playing, the branching playlist follows the “Social Issues” playlist 2402, as depicted in FIG. 25, depicting the example portion 2200 of the media map and the acceptance 2502 of the second branching playlist 2402.

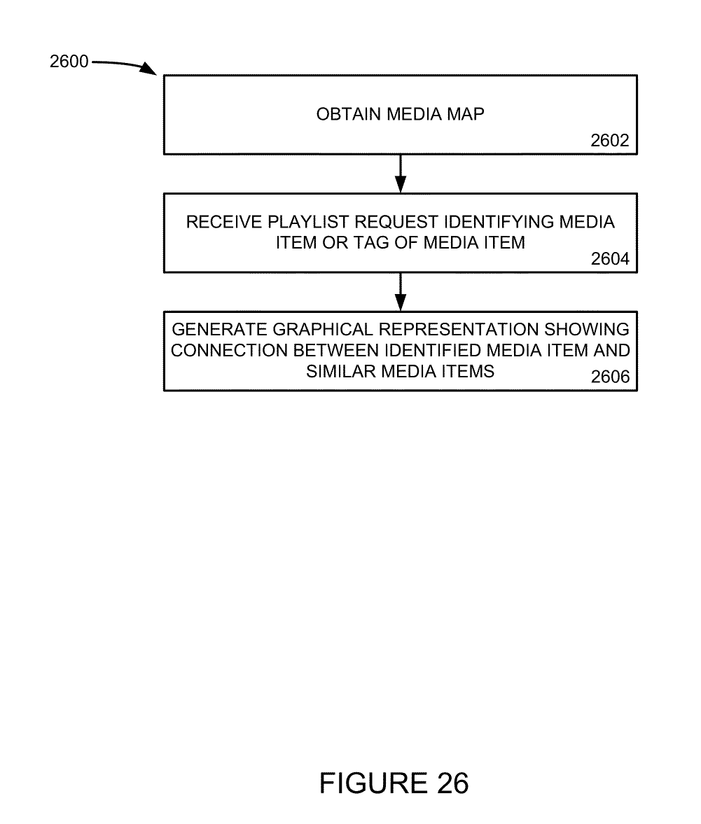

In a sixth example method, FIG. 26 is a flowchart of an example method 2600 for generating a playlist of media items based on similarity between the media items. In particular, such similarities can be used by the system to generate a graphical representation (e.g., a graphical display of a subway or other transportation line) of connections between media items having such similarity. As explained below, when a user selects, via a graphical user interface at the user display device 208, a media item or a stored tag of a media item, the generated graphical representation is used by the system as a playlist of media items along the graphical representation. The method 2600 can be performed by the media management system 202.

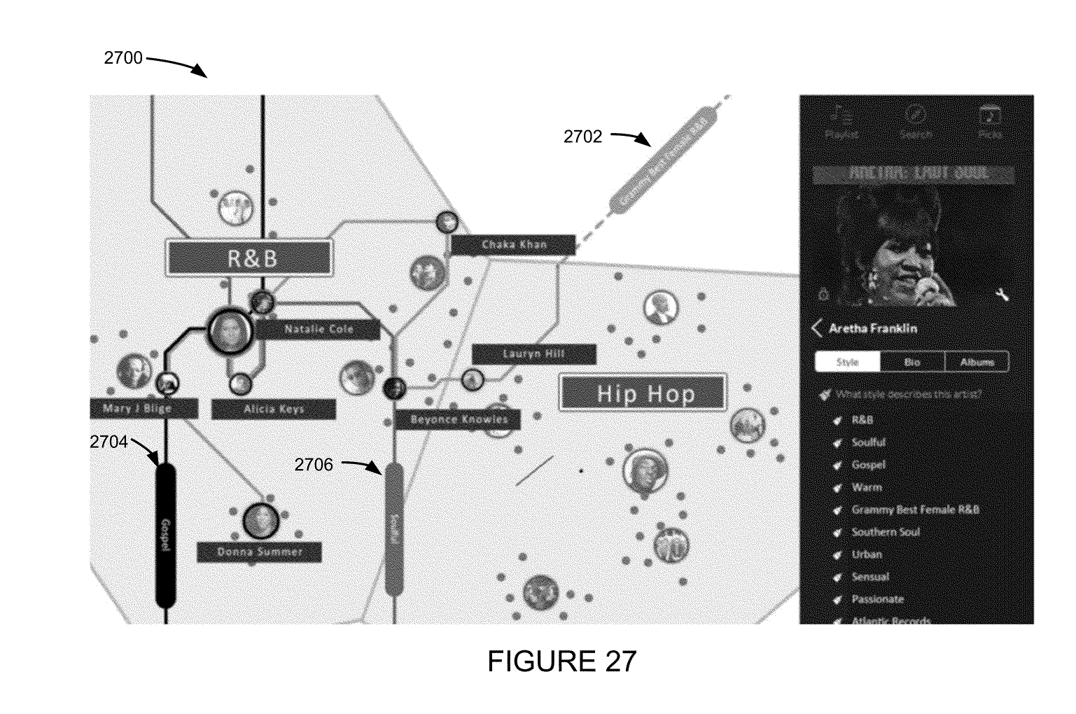

In an operation 2602, a media map (or a portion thereof) is obtained. The obtained media map can be provided as a graphical user interface via the user display device 208. An example portion of a region 2700 of a media map is shown in FIG. 27 which includes a graphical representation showing a connection between media items.

In an operation 2604, a playlist request is received from the user. The playlist request includes an identification of a media item or an identification of a tag of a media item in the media map. In the example portion of the region 2700 of the media map shown in FIG. 27, a user has identified a tag of “Soulful” of a media item “Aretha Franklin”.

In an operation 2606, the system creates the graphical representation showing a connection between media items, e.g., one or more subway line, based on the user identified tag or media item. What subway line(s) to display when a media object is identified is determined as follows. The system first iterates through all tags (e.g., genres, decades, geographies, etc.) on media M of the media map, defined as M_TAGS. A new list M_ALL_TAGS is then created, which is sorted to find top tags. For each tag T in M_TAGS, the system multiplies the weight of T by a factor corresponding to type. For example, GENRE_FACTOR=1 and DECADE_FACTOR=0, and GEO_FACTOR=0 would only show genre subway lines. Alternatively, GENRE_FACTOR=5 and DECADE_FACTOR=1, and GEO_FACTOR=1 could show any of the three types of subway lines, but would primarily show genre if it had a strong enough initial weight. The resulting tag is added to M_ALL_TAGS with the T.factored_weight=FACTOR*T.weight. M_ALL_TAGS are then sorted in descending order by T.factored_weight with, in one embodiment, the first three being as selected as M_TOP_TAGS. Alternatively, the maximum number of top tags can be tuned or set to a different fixed number or be variable and contingent on what can be displayed on the display screen. Either way, the system then generates the graphical representation (e.g., the subway line) for T in M_TOP_TAGS as will now be described.

The system determines which graphical representation, e.g., a subway line, to generate for a given tag T as follows. For all media items MEDIA_OBJECTS that have the identified tag T, a graph SUBWAY_GRAPH of Delaunay edges (as known in the art and as described in http://en.wikipedia.org/wiki/Delaunay_triangulation) is calculated. A tree SUBWAY_TREE is calculated across SUBWAY_GRAPH using a minimum spanning tree algorithm (as known in the art and as described in http://en, kipedia.org/wiki/Mini n spanning tree). Optionally, the SUBWAY_TREE can be pruned down to only the longest path through the tree. Alternatively, it could be adjusted to restrict the number of subway paths (and graphically displayed visual density) on the map. For each edge E in SUBWAY_TREE (or the pruned representation) with a starting media item of E_START and ending media object of E_END, a section of the subway is drawn on the displayed map from E_START to E_END. In one embodiment each section is drawn using 90 and 45 degree elbows. The resulting generated subway line(s) connect media items on the map without modifying their locations and can be used as a playlist of the connected media items.

In the example of top tags for “Aretha Franklin” shown in FIG. 27, subway lines for “Soulful” 2706, “Gospel” 2704, and “Grammy Best Female R&B” 2702 are shown connecting the representation of “Aretha Franklin” to other artists (for example, “Beyonce Knowles” and “Mary J Bilge”) on the map.

In an alternative embodiment, the system first generates the graphical representation of the similarity(ies) between media items and then the user identifies which media item or media item tag is to be used as a playlist by identifying the generated graphical representation. In other words, in this alternative embodiment the subway line(s) are first generated by the system and then the user identifies which displayed subway line is to be used as a playlist of media items along that identified subway line.

The playlists generated using the systems and methods described herein reflect the characteristics of the media items by virtue of being based on media maps. The playlists can be generated from a variety of inputs from the user. These inputs are playlist requests that can include an identification of a region, an identification of a starting media item and an ending media item, a user-defined area, a user-defined path, and/or an identified metadata tag. The systems and methods described herein can further generate branching playlists based on a currently playing media item.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. For example, embodiments described in the context of media maps can also be practiced in the context of hierarchical trees. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
obtaining, by a computing system, a media map comprising media map cells corresponding to media items, the media map including a plurality of regions, each region comprising a portion of the media map cells and sub-divided into sub-regions;
receiving, by the computing system, a selection of a region of the plurality of the regions of the media map that instructs the computer system to generate a playlist of media items from the selected region;
determining, by the computing system, a selection quantity of the media items corresponding to the media map cells from each sub-region of the selected region based on:
i) a target length of the playlist, and
ii) a total number of media items corresponding to the media map cells in the selected region;
selecting, by the computing system and from each sub-region, a number of media items equal to the selection quantity, by selecting:
i) a representative media item of the sub-region, and
ii) additional media items that are descendants of the representative media item; and
ordering, by the computing system and according to sub-region, the selected representative media items and the selected additional media items.

2. The method of claim 1, further comprising determining, by the computing system, the target length of the playlist based on a playback history of the user.

3. The method of claim 1, further comprising determining, by the computing system, the target length of the playlist based on a pre-defined percentage of the number of media items in the selected region.

4. The method of claim 1, wherein ordering the selected representative media items and the selected additional media items further comprises ordering the sub-regions of the identified region according to prominence level.

5. A method comprising:
obtaining, by a computing system, a media map comprising media map cells corresponding to media items, the media map including a plurality of regions, each region comprising a portion of the media map cells and sub-divided into sub-regions;
receiving, by the computing system, a user selection of a starting media map cell and a user selection of an ending media map cell within the media map that instructs the computing system to generate a playlist of media items that begins with a media item corresponding to the starting media map cell and ends with a media item corresponding to the ending media map cell;
determining, by the computing system, a target prominence range based on a prominence level of the starting media map cell and a prominence level of the ending media map cell;
identifying, by the computing system, candidate media map cells within the target prominence range that are located in the media map between the starting media map cell and the ending media map cell;
determining, by the computing system, a shortest path from the starting media map cell to the ending media map cell traversing the candidate media map cells;
selecting, by the computing system, media items corresponding to the traversed candidate media map cells; and
ordering, by the computing system, a first media item corresponding to the starting media map call, the selected media items, and a second media item corresponding to the ending media map cell according to the determined shortest path.

6. The method of claim 5, wherein the user selection of the starting media map cell is received before the user selection of the ending media map cell.

7. The method of claim 5, wherein the target prominence range is based on a visual representation of the obtained media map.

8. The method of claim 5, further comprising selecting, by the computing system, additional media items corresponding to additional media map cells within a same region as the traversed candidate media map cells.

9. A method comprising:
obtaining, by a computing system, a media map comprising media map cells corresponding to media items, the media map including a plurality of regions, each region comprising a portion of the media map cells and sub-divided into sub-regions;
receiving, by the computing system, a user-defined area encompassing a portion of at least one of the sub-regions of the media map;
calculating, by the computing system, a total number of media items corresponding to the media map cells within the user-defined area;
determining, by the computing system, for each sub-region having at least a portion encompassed by the user-defined area, a selection quantity of the media items corresponding to the media map cells within the user-defined area for selection based on:
i) a target length of the ordered list, and
ii) the total number of media items;
selecting, by the computing system, representative media items within the user defined area and children of the representative media items within the user defined area; and
ordering, by the computing system and according to sub-region, the representative media items and the children of the representative media items.

10. The method of claim 9, wherein the user-defined area is defined by a radius drawn about a center point of the user-defined area.

11. The method of claim 9, further comprising determining the target length of the ordered list based on a playback history of the user.

12. The method of claim 9, further comprising selecting, by the computing system, at least one descendent of one of the children of the representative media items based on the target length.

13. A method comprising:
obtaining, by a computing system, a media map comprising media map cells corresponding to media items, the media map including a plurality of regions, each region comprising a portion of the media map cells and sub-divided into sub-regions;
receiving, by the computing system, a user-defined path traversing at least one of the sub-regions of the media map;
selecting, by the computing system, media items corresponding to media map cells traversed by the user-defined path;
determining, by the computing system, a likelihood of inclusion of additional media items based on a distance between the media map cell to which the additional media item corresponds and the user-defined path;
selecting, by the computing system, an additional media item based on its likelihood of inclusion; and
ordering, by the computing system, the selected additional media item and the selected identified media items based on the user-defined path.

14. The method of claim 13, further comprising determining, by the computing system, a target prominence range based on a zoom level of the media map as presented to the user.

15. The method of claim 13, wherein selecting an additional media item is further based on a minimum distance requirement.

16. The method of claim 13, wherein the additional media item has more than one likelihood of inclusion.

17. A method comprising:
obtaining, by a computing system, a media map comprising media map cells corresponding to media items, the media map including a plurality of regions, each region comprising a portion of the media map cells and sub-divided into sub-regions;
receiving, by the computing system, an identification of at least one metadata tag associated with one of the media items;
identifying, by the computing system, a plurality of the media items associated with the at least one metadata tag;
identifying, in the media map and by the computing system, a plurality of the media map cells, including a starting media map cell and an ending media map cell, each of the plurality of the media map cells corresponding to one of the identified plurality of the media items;
identifying, by the computing system, candidate media map cells that are located in the media map between the starting media map cell and the ending media map cell;
determining, by the computing system, a shortest path from the starting media map cell to the ending media map cell traversing the candidate media map cells;
selecting, by the computing system, the media items corresponding to the traversed candidate media map cells; and
ordering, by the computing system, a first media item corresponding to the starting media map call, the selected media items, and a second media item corresponding to the ending media map cell, according to the shortest path.

18. The method of claim 17, further comprising:
identifying, by the computing system, a second at least one metadata tag associated with a currently presented media item;
identifying, by the computing system, a second plurality of media items associated with the second at least one metadata tag;
identifying, in the media map and by the computing system, a second plurality of the media map cells, including a second starting media map cell corresponding to the current media item and a second ending media map cell, each of the second plurality of the media map cells corresponding to one of the second identified plurality of the media items;
identifying, by the computing system, second candidate media map cells that are located in the media map between the second starting media map cell and the second ending media map cell;
determining, by the computing system, a shortest path from the second starting media map cell to the second ending media map cell traversing the second candidate media map cells;
selecting, by the computing system, the media items corresponding to the second traversed candidate media map cells; and
ordering, by the computing system, the current media item corresponding to the second starting media map call, the second selected media items, and a third media item corresponding to the second ending media map cell, according to the shortest path from the second starting media map cell to the second ending media map cell traversing the second candidate media map cells.

19. A method comprising:
obtaining, by a computing system, a media map comprising media map cells corresponding to media items, the media map including a plurality of regions, each region comprising a portion of the media map cells and sub-divided into sub-regions;
receiving, by the computing system, a user selection of a starting media map cell and determining, by the computing system, an ending media map cell within the media map that instructs the computing system to generate a playlist of media items that begins with a media item corresponding to the starting media map cell and ends with a media item corresponding to the ending media map cell;
determining, by the computing system, a target prominence range based on a prominence level of the starting media map cell and a prominence level of the ending media map cell;
identifying, by the computing system, candidate media map cells within the target prominence range that are located in the media map between the starting media map cell and the ending media map cell;
determining, by the computing system, a shortest path from the starting media map cell to the ending media map cell traversing the candidate media map cells;
selecting, by the computing system, media items corresponding to the traversed candidate media map cells; and
ordering, by the computing system, a first media item corresponding to the starting media map call, the selected media items, and a second media item corresponding to the ending media map cell according to the determined shortest path.

20. The method of claim 19, wherein the user selection of the starting media map cell is received before the user selection of the ending media map cell.

21. The method of claim 19, wherein the target prominence range is based on a visual representation of the obtained media map.

22. The method of claim 19, further comprising selecting, by the computing system, additional media items corresponding to additional media map cells within a same region as the traversed candidate media map cells.

19. The method of claim 18, further comprising:
presenting, by the computing system, the ordered current media item corresponding to the second starting media map call, the second selected media items, and a third media item corresponding to the second ending media map cell;
receiving, by the computing system, an acceptance of the ordered current media item corresponding to the second starting media map call, the second selected media items, and a third media item corresponding to the second ending media map cell; and
presenting, by the computing system, the second selected media items.

20. The method of claim 17, wherein the one of the media items corresponds to the starting media map cell.

21. A method comprising:
obtaining, by a computing system, a media map comprising media map cells corresponding to media items, the media map including a plurality of regions, each region comprising a portion of the media map cells and sub-divided into sub-regions;
identifying, by the computing system, at least one metadata tag associated with a currently presented media item of the media items;
identifying, by the computing system, a plurality of the media items associated with the at least one metadata tag;
identifying, in the media map and by the computing system, a plurality of the media map cells, including a starting media map cell corresponding to the currently presented media item and an ending media map cell, each of the plurality of the media map cells corresponding to one of the identified plurality of the media items;
identifying, by the computing system, candidate media map cells that are located in the media map between the starting media map cell and the ending media map cell;
determining, by the computing system, a shortest path from the starting media map cell to the ending media map cell traversing the candidate media map cells;
selecting, by the computing system, the media items corresponding to the traversed candidate media map cells; and
ordering, by the computing system, the currently presented media item corresponding to the starting media map call, the selected media items, and a second media item corresponding to the ending media map cell, according to the shortest path.

22. A method comprising:
obtaining, by a computing system, a media map comprising media map cells corresponding to media items, the media map including a plurality of regions, each region comprising a portion of the media map cells and sub-divided into sub-regions;
receiving, by the computing system, a user selection of a media map cell within the media map that instructs the computing system to generate a playlist of media items that begins with the media item corresponding to the selected media map cell;
generating, by the computing system, a graphical representation showing connection between the selected media map cell and other media map cells of the media map by:
identifying tags of the media items of the media map cells;
multiplying the identified tags by a tag factor to create a set of weighted tags;
sorting the weighted tags in descending order; and
selecting a subset of the sorted weighted tags;
then, for each selected sorted weighted tag, calculating a graph of Delaunay edges.

23. A method comprising:
obtaining, by a computing system, a media map comprising media map cells corresponding to media items, the media map including a plurality of regions, each region comprising a portion of the media map cells and sub-divided into sub-regions;
generating, by the computing system, a graphical representation showing connection between one media map cell of the media map and other media map cells of the media map by:
identifying tags of the media items of the media map cells;
multiplying the identified tags by a tag factor to create a set of weighted tags;
sorting the weighted tags in descending order; and
selecting a subset of the sorted weighted tags;
then, for each selected sorted weighted tag, calculating a graph of Delaunay edges;
receiving, by the computing system, a user selection of the graphical representation showing connection between the one media map cell of the media map and other media map cells of the media map thereby instructing the computing system to generate a playlist of media items that begins with the media item corresponding to the selected media map cell and continues with other media map cells along the graphical representation.
